(19) United States
(12) Patent Application Publication
(10) Pub. No.: US 2026/0148651 A1
(43) Pub. Date: May 28, 2026

(54) MULTIPLE INTELLIGENCES RECOGNITION AND ACTIVITY SYSTEM (MIRA SYSTEM)

(71) Applicant: Holy Spirit University of Kaslik, New York, NY (US)

(72) Inventors: Amena Jamal Allouch, Jounieh (LB); Wadih Skayem, Jounieh (LB); Kassem Hallal, Jounieh (LB)

(73) Assignee: Holy Spirit University of Kaslik, Jounieh (LB)

(21) Appl. No.: 18/956,560

(22) Filed: Nov. 22, 2024

(51) Int. Cl. G09B 5/12

(52) U.S. Cl. CPC G09B 5/12

(57) ABSTRACT

The present invention is a Multiple Intelligences Recognition and Activities System (MIRA System) that observes a student's activities inside the classroom, identifies a multiple intelligence that needs to be supplemented or is least detected for the student, and recommends activities directed to the least detected multiple intelligence(s) for each student in the class. A classroom may be in building, in a remote environment such as a home school, or outside of a building. The MIRA System comprises a digital camera or a mobile digital device and a computer program that processes captured pictures and videos from the camera, analyzes the quantity of each multiple intelligence activity for each student in the class and then recommends activities to enhance multiple intelligence skills related to the teacher's objectives.

### FIELD OF THE INVENTION

The present invention is related to education technology (learning method, multiple intelligence) for improving cognitive skills in the classroom.

### BACKGROUND OF THE INVENTION

In “Frames of Mind: The Theory of Multiple Intelligences,” Gardner et al. theorized that people have different kinds of “intelligences” or “multiple intelligences” (“MI”). Dr. Howard Gardener proposed that these different types of multiple intelligence were: visual-spatial, linguistic-verbal, logical-mathematical, body-kinesthetic, musical, interpersonal, intrapersonal and naturalistic. Individuals draw on these multiple intelligences, separately or in combination, to solve problems (Gardner et al., 2011).

The theory of multiple intelligences proposed by Gardner et al. differs from the traditional concept of intelligence, typically measured in an IQ test. Gardner has suggested that the intelligence measured in an IQ test only utilizes two of the eight multiple intelligences proposed by Gardner. The multiple intelligences measured in an IQ test are only the linguistic-verbal multiple intelligence and the logical multiple intelligence (Gardner et al., 2011).

US Patent Publication No. 2010291527A1 discloses a kit and process for diagnosing a multiple intelligence profile of an individual with verbal communication limitations from observational behavior.

KR20110055215A, entitled “Method for Multiple Intelligence Based Aptitude Test, Method and System for On-Line Career Aptitude Testing,” relates to an online carrier aptitude testing method and system that analyzes a personal multiple intelligence pattern and a result-centered/management-centered pattern.

KR20190076722A, entitled “VR/AR Method and System for Testing Multiple-Intelligence based on VR/AR using Mobile Device,” discloses a multiple intelligence test method based on VR/AR using a mobile device.

CN108140226A relates to a system and a method for a multiple intelligence test.

Siddig 2021 discloses an evaluation of multiple intelligences in a textbook. Al-Qatawneh, Alsalhi, Eltahir, and Siddig (“The representation of multiple intelligences in an intermediate Arabic-language textbook, and teachers'awareness of them in Jordanian schools.” Heliyon. May 2021; Vol. 7(5): e07004. (DOI: 10.1016/j.heliyon.2021.e07004)) (“Siddig 2021”).

Pan 2024 discloses the use of Brain Computer Interface (“ CI”) technology to measure brain activity associated with specific skills or abilities. Pan, Z., Cristea, A.I. (2024). Towards Neuro-Enhanced Education: A Systematic Review of BCI-Assisted Development for Non-academic Skills and Abilities. In: Sifaleras, A., Lin, F. (eds) Generative Intelligence and Intelligent Tutoring Systems. ITS 2024. Lecture Notes in Computer Science, vol 14799. Springer, Cham. https://doi.org/10.1007/978-3-031-63031-6_5 (“Pan 2024”). Specifically, BCI technology is technology where students wear or link electrodes to the student's head in order to process information.

None of the cited references refers to the multiple intelligences recognition system of the present invention.

### BRIEF SUMMARY OF THE INVENTION

The present invention provides an artificial intelligence (AI) system that recognizes and supports multiple intelligence activities. The multiple intelligences recognition system comprises a digital camera and computer program, wherein the camera captures photos and videos and stores the photos and videos in a multiple intelligences recognition system. The multiple intelligences recognition system then analyzes the captured photos and videos into types of multiple intelligences and recommends at least one activity for each multiple intelligence identified.

In one embodiment, the multiple intelligences recognition system comprises a digital camera and computer program, wherein the digital camera captures photos and videos and stores the photos and videos in a multiple intelligences recognition system.

In a further embodiment, the multiple intelligences recognition system analyzes the captured photos and videos into types of multiple intelligences, identifies at least one deficient multiple intelligence and recommends at least one activity for each deficient multiple intelligence identified.

In a further embodiment, the multiple intelligence of the multiple intelligences recognition system is spatial, kinesthetic, logical, linguistic, musical, naturalistic, interpersonal or intrapersonal.

In a further embodiment, the multiple intelligences recognition system comprises a recommendation module, wherein the computer program recommends certain multiple intelligence activities to enhance a deficient cognitive skill.

In a further embodiment, the spatial multiple intelligence of the multiple intelligences recognition system is spatial perception, spatial visualization, spatial reasoning, pattern recognition, design, artistic expression, navigation or a combination thereof.

In a further embodiment, the kinesthetic multiple intelligence of the multiple intelligences recognition system is body control, fine motor skills, physical expression, athletic ability, body language, kinesthetic learning or a combination thereof.

In a further embodiment, the logical multiple intelligence of the multiple intelligences recognition system is logical reasoning, deductive reasoning, problem-solving, mathematical operations, data analysis or a combination thereof.

In another embodiment, the linguistic multiple intelligence of the multiple intelligences recognition system is verbal communication, written communication, reading comprehension, vocabulary, wordplay, storytelling or a combination thereof.

In a further embodiment, the musical multiple intelligence of the multiple intelligences recognition system is musical perception, musical memory, instrumental proficiency, vocal proficiency, musical composition, musical production, music theory, musical performance or a combination thereof.

In a further embodiment, the naturalistic multiple intelligence of the multiple intelligences recognition system is observational skills, ecological knowledge, environmental stewardship, outdoor skills, agricultural knowledge, geographical knowledge, environmental design, conservation biology or a combination thereof.

In a further embodiment, the interpersonal multiple intelligence of the multiple intelligences recognition system is communication, collaboration, leadership, networking, social awareness, conflict resolution, cultural competence or a combination thereof.

In a further embodiment, the intrapersonal multiple intelligence of the multiple intelligences recognition system is self-awareness, self-reflection, goal setting, metacognition, mindfulness, autonomy, resilience or a combination thereof.

In one embodiment, the multiple intelligences recognition system of the present invention comprises: a data ingestion module configured to receive and preprocess data; a feature extraction module operable to extract relevant features from the preprocessed data; a machine learning model training module configured to train machine learning models on the extracted features; a prediction module operable to generate predictive outcomes based on real-time input data using the trained machine learning models and a user interface enabling users to input data and view predictions.

In a further embodiment, the multiple intelligences recognition system of the present invention further comprises a recommendation module that provides actionable insights based on the generated predictions.

In a further embodiment, the data ingestion module of the multiple intelligences recognition system is a digital camera.

In a further embodiment, the data ingestion module of the multiple intelligences recognition system supports real-time data streaming for continuous data flow and predictive analytics.

In a further embodiment, the feature extraction module, the machine learning model training module, and the prediction module of the multiple intelligences recognition system is controlled by a computer program.

In a further embodiment, the relevant features of the feature extraction module of the multiple intelligences recognition system are multiple intelligences.

In a further embodiment, the computer program of the multiple intelligences recognition system normalizes and cleans said photos and videos to ensure data quality.

In a further embodiment, the computer program of the multiple intelligences recognition system comprises a step of creating a feedback loop to continuously improve the machine learning models based on new data and prediction outcomes.

In a further embodiment, the machine learning model training module of the multiple intelligences recognition system is adapted to implement ensemble learning techniques for improved prediction accuracy.

The MIRA System of the present invention comprises a digital camera or a mobile digital device linked to a computer program that saves data and processes it. The digital camera may be fixed in the classroom or a mobile device. The classroom is any environment where students are taught. The classroom may be in building, in a remote environment such as a home school, or outside of a building. The computer program is any program with computer readable instructions for causing a computer processor to carry out aspects of the present invention.

The camera is a digital camera or a mobile digital device that captures pictures and videos. The camera may be fixed or mobile. The camera may also be part of a laptop or a smart phone. The teachers and the students are not affected by the camera's existence. Compared to other tools or technologies used such as a brain computer interface (“BCI”) where students need to wear or link electrodes on the student's brains in order to process information, no electronic attachments are connected to students.

These and other objects, advantages, and features of the invention will become apparent to those persons skilled in the art upon reading the details of the formulations and methods as more fully described below.

### BRIEF DESCRIPTION OF THE DRAWINGS

The invention and its objects will be better understood when consideration is given to the following detailed description and associated figures. The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 is a flow-chart of how the computer program of the MIRA system analyzes data from a digital camera, classifies the captured data with a particular multiple intelligence and recommends at least one activity to enhance a particular multiple intelligence.

FIG. 2 is a schematic showing how the camera of the present invention detects and processes multiple intelligence activities.

FIG. 3 is a schematic showing how the camera of the present invention detects and processes multiple intelligence activities for Student X. Multiple Intelligence Activities for Student X are provided in November 2023 and approximately six weeks later.

FIG. 4 is Seeds Word Search Puzzle provided by the MIRA System of the present invention.

FIG. 5 is a schematic of a seed provided by the MIRA System of the present invention.

FIG. 6 is an example of a Seed Chant provided by the MIRA System of the present invention.

### DETAILED DESCRIPTION OF THE INVENTION

The main mission of schools is to develop the cognitive abilities of children starting from an early age. Early age is preferable as students'minds become less malleable later on. Primarily, cognitive abilities are tracked in schools by teachers through standardized tests and observations. However, these assessments, such as the standard IQ test, do not capture the full range of a student's cognitive abilities and skills. In addition, because of large class sizes, teachers face time constraints and may not be able to devote sufficient time to tracking and documenting a student's cognitive progress comprehensively. Consequently, a student may miss some cognitive skills in the early stage of his/her academic career that appear in the form of academic problems later on.

One way to assess cognitive ability is by grade level, as determined by a local or national elementary system.

Another way to assess cognitive ability is by utilizing the Woodcock Scale, or any number of other demonstrated-accurate cognitive scales.

Alternatively, another way to assess cognitive ability is by user specification. Users may employ their own means to determine their cognitive level. Once a cognitive level is determined, the level may then be input to the computer program.

Lastly, a user may answer a number of questions and the computer program will evaluate the answers and return a preliminary cognitive starting level. As these questions are not comprehensive, cognitive starting level may be +/−2 grades from a true cognitive level.

As a result of a loss of cognitive skills, students may reach grade 3 or higher and be assessed, for example, as students unable to read fluently. Some students are shy and do not express their feelings and opinions or are unable to determine that they are lacking certain cognitive skills. Accordingly, certain students may lack the ability and skills to present a topic in public. Some students don't have the ability to work in groups and many skills that are missed but not specified until higher ages. When these skills are missed from the beginning, reacquiring these skills again will be difficult and will need more effort. Furthermore, as some schools are adopting the idea of “no student left behind,” the MIRA System of the present invention allows one to follow and track a student's activities in order to promote a student's academic well-being.

The focus of this invention will be on elementary classes and younger students because cognition is at its highest potential in the early stages. However, the present invention may be applied to all ages. If multiple intelligences are integrated using artificial intelligence technology, the progress and growth of cognitive abilities may be tracked for each student, teachers will be notified of undeveloped or underdeveloped cognitive abilities and teachers will develop or enhance these undeveloped or underdeveloped cognitive abilities. If artificial intelligence is integrated into the classroom, academic problems will be minimized in the later stages of a student's academic career and a student's academic well-being is enhanced.

### Definitions

In this application, the use of the singular includes the plural unless specifically stated otherwise. As used herein, the singular forms “a,” “an” and “the” are intended to include the plural forms as well, unless the context clearly indicates otherwise.

In this application, the use of “or” means “and/or” unless stated otherwise. Also, when it is clear from the context in which it is used, “and” may be interpreted as “or,” such as in a list of alternatives where it is not possible for all to be true or present at once.

As used herein, the terms “comprises” and/or “comprising” specify the presence of the stated features, integers, steps, operations, elements, and/or components, but do not preclude the presence or addition of one or more other features, integers, steps, operations, elements, components, and/or groups thereof. Furthermore, to the extent that the terms “includes,” “having,” “has,” “with,” “composed,” “comprised” or variants thereof are used in either the detailed description or the claims, such terms are intended to be inclusive in a manner similar to the term “comprising.”

When the terms “consist of”, “consists of” or “consisting of” is used in the body of a claim, the claim term set off with “consist of”, “consists of” and/or “consisting of” is limited to the elements recited immediately following “consist of”, “consists of” and/or “consisting of”, and is closed to unrecited elements related to that particular claim term. The term ‘combinations thereof’, when included in the listing of the recited elements that follow “consist of”, “consists of” and/or “consisting of” means a combination of only two or more of the elements recited.

As used herein, the term “AI” or Artificial Intelligence is technology that enables computers and machines to simulate human intelligence and problem-solving capabilities.

As used herein, the term “camera” is a digital camera or a mobile digital device that captures pictures and videos. The camera may be fixed or mobile. The camera may also be part of a laptop or a smart phone. The camera may also be a webcam.

As used herein, the term “classroom” is any environment where students are taught. A classroom may be in building, in a remote environment such as a home school, or outside of a building. The term “classroom” also encompasses an environment where only one student is taught, such as a personalized learning environment.

As used herein, the term “computer program” refers to a program with computer readable instructions for causing a computer processor to carry out aspects of the present invention. As used herein, the term computer program may include at least one computer readable storage medium having computer readable instructions.

As used herein, the term “Human Activity Recognition Artificial Intelligence” (HAR AI) involves using advanced AI techniques to automatically identify and classify human activities from various data sources. HAR AI encompasses data collection, feature extraction, model training, and real-time activity recognition, with applications across numerous domains including healthcare, fitness, smart homes, security, and workplace safety.

As used herein, the term “IQ” refers to an intelligence quotient that is the total score derived from a set of standardized tests or subtests designed to assess human intelligence.

As used herein, the term “MIRA” refers to a Multiple Intelligences Recognition and Activities system. The MIRA system recognizes the type of multiple intelligence activities (visual-spatial, linguistic-verbal, logical-mathematical, body-kinesthetic, musical, interpersonal, intrapersonal and naturalistic) in each student and provides feedback to the teachers and administration about the multiple intelligence activities in a quantitative form (quantity applied, quantity for each type, in which class). For example, the MIRA system would identify the multiple intelligences of each student and describe and quantify the activities for each multiple intelligence.

As used herein, the term “multiple intelligence” refers to visual-spatial, linguistic-verbal, logical-mathematical, kinesthetic, musical, interpersonal, intrapersonal and naturalistic multiple intelligence.

As used herein, the term “multiple intelligence mapping” is determining or classifying an activity to a multiple intelligence.

### The MIRA System

The present invention comprises a Multiple Intelligences Recognition and Activities System (“MIRA System”). The MIRA System is a system that determines the type of activities done in the classroom and categorizes it as a type of multiple intelligence. The MIRA System then recommends multiple intelligence activities, in addition to multiple intelligence activities based on science objectives of the teacher.

MIRA refers to a Multiple Intelligences Recognition and Activities system. The MIRA system recognizes the type of activities (visual-spatial, linguistic-verbal, logical-mathematical, body-kinesthetic, musical, interpersonal, intrapersonal and naturalistic) conducted in the class and provides feedback for the teachers and administration about the activities applied in quantitative form (quantity applied, quantity for each type, in which class). The recognition will be done by using digital camera that captures videos/pictures at different instants and analyze it using artificial intelligence such as human activity recognition (HAR) library. The analyzed data (type of activities and quantities) in the MIRA system is recorded to evaluate educational quality. The MIRA system provides science-based content for multiple intelligence activities with documents (pictures, videos, sheets, games, materials and procedure, scripts) for grades 1 thru 6. However, the documents may also be directed to students in other grades, other languages, social studies, and any other subjects taught in non-elementary school grades.

The MIRA System observes student's activities inside the classroom and promotes applying more of the detected least type of activities done in the class. The aim of the MIRA System is to subject students to different multiple intelligence activities at an early age in order to develop academic skills and cognitive abilities. Preferably, the MIRA System is implemented in elementary grades 1, 2 and 3.

In one embodiment, the MIRA System comprises a digital camera or a mobile digital device and a computer program which controls the camera, stores the video data and analyzes the data. Preferably, the mobile digital device is not attached to the teacher or the student. The camera may be fixed or mobile. The camera may also be part of a laptop or a smart phone.

In another embodiment, the multiple intelligences recognition system of the present invention comprises: a data ingestion module configured to receive and preprocess data; a feature extraction module operable to extract relevant features from the preprocessed data; a machine learning model training module configured to train machine learning models on the extracted features; a prediction module operable to generate predictive outcomes based on real-time input data using the trained machine learning models and a user interface enabling users to input data and view predictions.

In a further embodiment, the multiple intelligences recognition system of the present invention further comprises a recommendation module that provides actionable insights based on the generated predictions.

In a further embodiment, the data ingestion module of the multiple intelligences recognition system comprises a digital camera. In a further embodiment, the data from the data ingestion module are photos and videos.

In a further embodiment, the data ingestion module of the multiple intelligences recognition system supports real-time data streaming for continuous data flow and predictive analytics.

In a further embodiment, the feature extraction module, the machine learning model training module, and the prediction module of the multiple intelligences recognition system is controlled by a computer program.

In a further embodiment, the relevant features of the feature extraction module of the multiple intelligences recognition system are multiple intelligences.

In a further embodiment, the multiple intelligence of the multiple intelligences recognition system is a spatial, kinesthetic, logical, linguistic, musical, naturalistic, interpersonal or intrapersonal multiple intelligence.

In a further embodiment, the computer program of the multiple intelligences recognition system normalizes and cleans the photos and videos of the data ingestion module to ensure data quality.

In a further embodiment, the computer program of the multiple intelligences recognition system comprises a step of creating a feedback loop to continuously improve the machine learning models based on new data and prediction outcomes.

In a further embodiment, the machine learning model training module of the multiple intelligences recognition system is adapted to implement ensemble learning techniques for improved prediction accuracy.

The MIRA system of the present invention is made up of two parts:
a digital camera or a mobile digital device that captures pictures and videos inside the classroom and saves the camera's video content in a linked computer program and a computer program. The “classroom” is any environment where students are taught. The classroom may be in building, in a remote environment such as a home school, or outside of a building. The “computer program” is any program with computer readable instructions for causing a computer processor to carry out aspects of the present invention. The computer program processes the captured pictures and videos into types of multiple intelligences. The computer program then saves the data and conducts a statistical analysis for the quantity of each multiple intelligence activities done in the class. The computer program recommends activities for each multiple intelligence and each skill related to objectives from the school curricula. Lastly, the program recommends for each multiple intelligence activity, resources such as games, puzzles, flash cards, scripts that are available to help teachers attain their objectives.

In one exemplary embodiment, the science objectives of the teacher is directed to plant science. Exemplary multiple intelligence activities based on this science objective for elementary schools grades are disclosed in Examples 5 thru 11.

The present invention provides an artificial intelligence (AI) system that detects and supports multiple intelligence activities. This MIRA Artificial Intelligence (“AI”) system comprises data from a digital camera and a computer program. The computer program controlling the digital camera saves the data from the camera. The digital camera and the computer program are programmed using Delphi 11.3 and Python programming language. Other programs may also be used to attain the same function. However, the Delphi 11.3 and Python programming languages are preferred.

This MIRA Artificial Intelligence (“AI”) system also provides documents that are structured using HTML. These documents are preferably science-based content for multiple intelligence activities with documents (pictures, videos, sheets, games, materials and procedure, scripts) for grades 1 thru 6. However, the documents may also be directed to languages, social studies, and any other subjects taught at an elementary school.

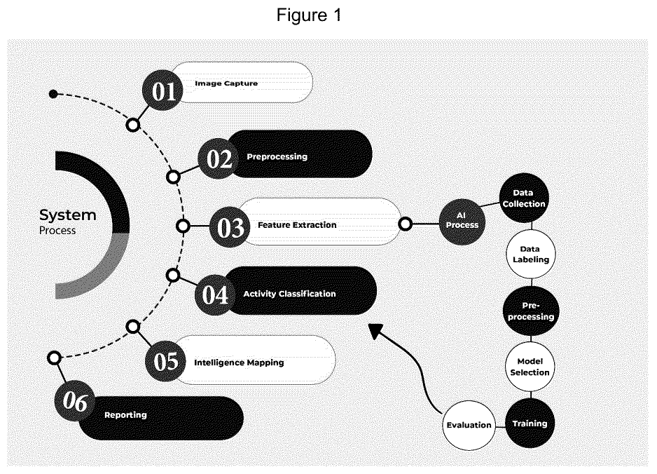

FIG. 1 is a flow-chart on how the computer program of the MIRA system analyzes data from the digital camera and recommends at least one multiple intelligence activity.

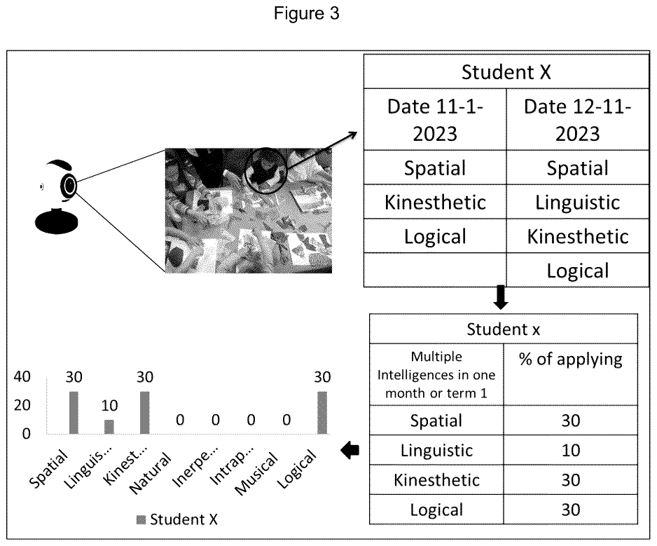

In one example, the digital camera takes videos or still photos of the students (step 1 of FIG. 1), detects multiple intelligence activities of the students and captures photos of their multiple intelligence activities. The computer program of the MIRA System then processes the captured photos (step 2 of FIG. 1) and translates the photos into types of multiple intelligence (step 3 of FIG. 1). As seen in the FIG. 1 flowchart, the MIRA System's digital camera takes and captures the digital images of the students (step 1). The MIRA System then preprocesses the digital images and resizes and normalizes them, as needed (step 2). The MIRA System then identifies the features associated with each multiple intelligence. This feature extraction process by the MIRA AI System (step 3) is shown in FIG. 3. The MIRA AI System collects the data, labels the data, preprocesses the data, selects the learning model as determined by the user or the teacher, trains models specifically designed to recognize and classify activities related to different multiple intelligences (step 4 of FIG. 1), and evaluates the data. After the feature extraction process by the MIRA System, the activities are classified (as seen in FIG. 3 for Student X), their multiple intelligence(s) mapped (step 4 of FIG. 1), and a Report (step 5 of FIG. 1), is generated for the teacher, as exemplified in FIG. 3.

### Deep Learning Process

The MIRA System comprises: a data ingestion module configured to receive and preprocess data; a feature extraction module operable to extract relevant features from the preprocessed data; a machine learning model training module configured to train machine learning models on the extracted features; a prediction module operable to generate predictive outcomes based on real-time input data using the trained machine learning models and a user interface enabling users to input data and view predictions. The AI system of the MIRA System reaches the level of multiple intelligence recognition through a deep learning process. The deep learning process for activity recognition by the MIRA System comprises two parts: 1) Data Collection of the Photos and Videos for the Data Ingestion Module and 2) Data Acquisition and Analysis from Photos and Videos captured in the class.

### Data Ingestion Module of the MIRA System

The following process describes data collection from photos and videos. The Data Collection of the Digital Camera Images for the Data Ingestion Module has the following steps: a) Data Collection of the Digital Camera Images, b) Data Labeling of each Digital Camera Image, c) Preprocessing of the Digital Image Data, d) Selection of Deep Learning Model Architecture, e) Training of the Data Set, and f) Evaluation of the Model's Performance.

The Data Collection of the Digital Images step (a) comprises: 1) the teacher collecting a large dataset of images and videos showing the children engaged in various classroom activities; and 2) the teacher ensuring that the dataset includes diverse activities that correspond to different types of multiple intelligences (e.g., logical-mathematical, linguistic, spatial, body-kinesthetic, musical, interpersonal, intrapersonal, and naturalistic).

### Feature Extraction Module of the MIRA System

The Feature Extraction Module of the MIRA System comprises labeling the Digital Image Data. The Data Labeling of each Digital Camera Image step (b) comprises the teacher labeling each image or video frame with the type of activity being performed and the corresponding intelligence type.

a. Manual Labeling

Exemplary tools for manually labeling the image or video frame are LabelImg and CVAT. LabelImg is an open-source graphical image annotation tool written in Python and uses the Qt for its graphical interface. LabelImg is available on GitHub and can be downloaded and used freely. CVAT is an open-source web-based tool for building computer vision datasets. LabelImg is developed and maintained by the OpenVINO toolkit team and is available on GitHub under an MIT license, allowing it to be used freely. LabelImg is available at https://github.com/cvat-ai/cvat, retrieved on 2024-11-20. Qt is a brand name for the free and open-source widget toolkit for creating a graphical user interfaces. Qt is available at https://doc.qt.io/qt-6/topics-ui. html, retrieved on 2024-11-20.

The Preprocessing of the Digital Image Data step (c) comprises the teacher or teacher's assistant resizing and normalizing the digital images obtained by the camera to a standard size and scale. The digital images of the data set may be augmented with techniques such as rotation, flipping, and cropping to increase variability and robustness of the data set.

b. AI Labeling

Feature extraction can also be conducted by the AI of the MIRA System. As shown schematically in step 3 of FIG. 1, the AI process begins with (1) data collection of the data (in the form of captured image or video), (2) labeling the data, (3) pre-processing the data, (4) model selection, (5) training and (6) evaluation. Feature extraction involves reviewing the captured data, evaluating the data and associating the data with a particular multiple intelligence or multiple intelligences.

In the feature extraction step of the AI process of FIG. 1, there is a model selection step. Suitable deep learning models that may be selected are EfficientNet and ResNet.

EfficientNet offers a range of model sizes (B0 to B7) that can be selected based on the available computational resources. EfficientNet achieves high accuracy in image classification tasks without excessive computational demands. It is particularly effective in recognizing and categorizing images across various datasets, including large-scale benchmarks like ImageNet, while balancing accuracy and computational efficiency.

ResNet (Residual Networks) is effective for training very deep networks due to its skip connections, which help mitigate the vanishing gradient problem. The vanishing gradient problem is a challenge encountered during the training of deep neural networks, particularly those with many layers. It occurs when the gradients—used to update the model's weights during backpropagation—become exceedingly small as they are propagated back through the layers. The Vanishing Gradient Problem can lead to slow learning, shallow representations, and poor performance. Slow Learning occurs when gradients are very small and the weight updates for the earlier layers become negligible. This results in slow learning for those layers, causing the network to struggle to adjust and improve its performance. As a consequence of slow learning, the network may effectively behave like a much shallower network, limiting its ability to capture complex patterns in the data. The vanishing gradient problem is particularly prevalent in deep networks using activation functions like sigmoid or tanh, which can reduce gradients to small values. If the gradients vanish completely, the network may stop learning altogether, leading to poor performance and convergence issues.

Some solutions to the Vanishing Gradient Problem are activation functions, skip connections and batch normalization. Use of activation functions, such as ReLU (Rectified Linear Unit) that do not saturate, can help mitigate the Vanishing Gradient Problem. Skip Connections also help mitigate the Vanishing Gradient Problem by allowing gradients to flow more easily through the network. Lastly, Batch Normalization helps mitigate the Vanishing Gradient Problem by allowing the normalization of inputs of each layer, which in turn helps maintain appropriate gradient scales.

Skip connections, shortcut connections, are used in neural networks, particularly in architectures such as ResNet. Skip connections allow for the input of one layer to be added directly to the output of a deeper layer, effectively bypassing one or more layers in between. The key points about skip connections are they mitigate vanishing gradients, facilitate the training of deeper networks, improve feature propagation and promote residual learning. Skip connections mitigate Vanishing Gradients by providing an alternative path for gradients to flow during backpropagation. Skip connections help address the vanishing gradient problem, which can occur in very deep networks. In addition, skip connections facilitate Training of Deeper Networks by making it possible to train much deeper networks (e.g., hundreds or thousands of layers) without suffering from degradation in performance. Further, skip connections improve Feature Propagation by allowing features learned in earlier layers to be reused in later layers, which can enhance the model's ability to learn complex patterns. Lastly, the architecture of skip connections promotes a residual learning framework, i.e. the network learns the residual mapping (the difference) between the input and the desired output rather than learning the output directly.

Whether one uses the Manual Labeling process or the AI Labeling process, the end result is the same for both the Manual Labeling process and the AI Labeling process.

### Machine Learning Model Training Module of the MIRA System

The machine learning model training module is configured to train machine learning models on the extracted features. The Selection of Deep Learning Model Architecture step (d) comprises the teacher choosing a deep learning model architecture suitable for image recognition, such as Convolutional Neural Networks (“CNN” or “ConvNets”). Convolutional Neural Networks are ensemble learning techniques. Ensemble learning techniques improve the prediction accuracy of the multiple intelligences recognition system. Popular models of Convolutional Neural Networks include Visual Geometry Group (VGGNet) (Simonyan et al., 2015) (available at https://arxiv.org/abs/1409.1556), ResNet (He et al., 2015) (available at https://arxiv.org/abs/1512.03385), and InceptionNet (Szegedy et al., 2014) (available at https://arxiv.org/abs/1409.4842).

The Training of the Data Set step (e) comprises: 1) the teacher splitting the dataset into training, validation, and test sets and 2) the teacher training the model using a deep learning framework such as, for example, TensorFlow or PyTorc. TensorFlow is an open-source machine learning library developed by the Google Brain team (https://www.tensorflow.org/, retrieved on 2024-11-20) and PyTorch is an open-source machine learning library developed by the Facebook AI Research lab (available at https://pytorch.org/, retrieved on 2024-11-20). The teacher utilizes techniques such as transfer learning with pre-trained models to improve the performance of the model and reduce training time of the model.

### Prediction Module of the MIRA System

The prediction module of the MIRA System generates predictive outcomes based on real-time input data using the trained machine learning models and a user interface enabling users to input data and view predictions. The teacher evaluates the model's performance using metrics such as accuracy, precision, recall, and F1-score. The F1-score is a performance metric used to evaluate the overall performance of a classification model. It is the harmonic mean of the model's precision and recall, and is calculated as follows:

$$F 1 - score = [ 2 * ( Precision * Recall ) ] / ( Precision + Recall ) .$$

“Precision” is defined as the proportion of true positive predictions out of all positive predictions made by the model. “Recall” is defined as the proportion of true positive predictions out of all actual positive instances in the dataset. The F1-score ranges from 0 to 1, with 1 being the best score (highest precision and recall) and 0 being the worst. The teacher may fine-tune the model based on the evaluation results of the model to improve the model's accuracy.

### Data Analysis

In one embodiment, the MIRA System analyzes the captured photos and videos into types of multiple intelligences, identifies at least one deficient multiple intelligence and recommends at least one activity for each deficient multiple intelligence identified. The deep learning model for activity recognition by the MIRA System comprises two parts: 1) Data Collection of the Photos and 2) Data Acquisition and Analysis from Photos captured in the class. The second part (Data Acquisition and Analysis from Photos) has the following steps: (1) Image Capture, (2) Preprocessing, (3) Feature Extraction, (4) Activity Classification, (5) Multiple Intelligence Mapping, and (6) Reporting.

In the Image Capture step (1), the MIRA System captures still photos of classroom activities using cameras or mobile devices. The teacher ensures that high-quality images with sufficient resolution and clarity are being taken.

In the Preprocessing step (2), the MIRA System preprocess the images by resizing, normalizing, and enhancing the captured images for better analysis.

In the Feature Extraction step (3), the MIRA System uses the trained deep learning model to extract features from the digital images. The MIRA System identifies key points, shapes, and patterns related to different activities.

In the Activity Classification step (4), the MIRA System classifies each image based on the extracted features. The MIRA System determines the type of activity and the corresponding multiple intelligence type.

In the Multiple Intelligence Mapping step (5), the MIRA System maps the classified activities of step (4) to a corresponding multiple intelligence type. The MIRA System then analyzes the frequency and distribution of different activities to identify dominant multiple intelligences.

Lastly, in the Reporting step (6), the MIRA System generates reports summarizing the types of activities and corresponding multiple intelligences for each child. The reports provide insights and recommendations for personalized education based on the identified multiple intelligences of the student.

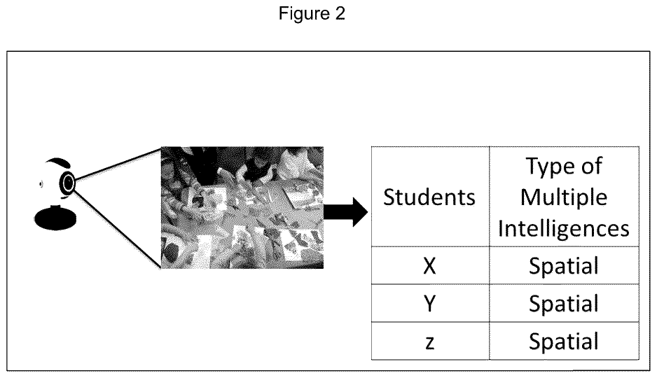

As shown in FIG. 2, the camera system comprises any digital camera. Any digital camera coded using human activity recognition Artificial Intelligence (“HAR AI”) may be used. Human Activity Recognition AI refers to the use of artificial intelligence techniques to automatically identify and understand human actions and activities from data, such as video, images, sensor data, or other inputs. This technology has a wide range of applications, from education, to healthcare and fitness tracking to smart home automation and security.

The key concepts of HAR AI for the present invention are the 1) data sources, 2) feature extraction from the digital data, 3) model training, and 4) classification of multiple intelligence activities. In one embodiment, the multiple intelligences recognition system of the present invention comprises: a data ingestion module configured to receive and preprocess data; a feature extraction module operable to extract relevant features from the preprocessed data; a machine learning model training module configured to train machine learning models on the extracted features; a prediction module operable to generate predictive outcomes based on real-time input data using the trained machine learning models; and a user interface enabling users to input data and view predictions.

Data Sources for HAR AI may include video and image data, sensor data and audio data. Video and Image Data may be obtained from digital cameras that capture visual data of human activities. Sensor Data may include data from wearable devices, smartphones, and IoT sensors. IoT (Internet of Things) sensors refer to devices that are capable of collecting and transmitting data over the internet or a network. These sensors are typically small, embedded devices that are designed to monitor and measure various physical or environmental conditions. IoT sensors collect data such as accelerometer and gyroscope readings. Audio Data may be obtained from microphones which capture sounds associated with certain activities.

Feature Extraction for HAR AI may include visual, temporal and sensor features. In video and images, HAR AI extracts visual features such as body poses, movements, and object interactions using techniques like convolutional neural networks (CNNs). Temporal Features may be obtained from analyzing sequences of frames to understand the progression of movements over time. Sensor Features may be obtained from processing signals from accelerometers, gyroscopes, and other sensors to identify patterns corresponding to specific activities.

Model Training for HAR AI may include supervised, deep learning or transfer learning. Supervised Learning comprises utilizing labeled datasets where the activities are pre-identified, the model learns to recognize patterns associated with different activities. Deep Learning comprises leveraging deep neural networks, particularly recurrent neural networks (RNNs) and long short-term memory (LSTM) networks, to handle the temporal aspect of activities. Transfer learning comprises using pre-trained models and fine-tuning them on specific activity datasets to enhance performance and reduce training time.

Activity Classification for HAR AI may include Classification Algorithms and Real-time Processing. Classification Algorithms are models that classify activities based on extracted features. Common algorithms used for human activity recognition (“HAR”) include decision trees, support vector machines (SVMs), and deep learning models. These algorithms are trained on labeled data (e.g., sensor data with corresponding activity labels) to learn the patterns and features that distinguish different activities.

Real-time Processing is a model that implements and processes data for human activity recognition in real-time to recognize activities as they occur. Real-time Processing is an important aspect of HAR, as it allows the MIRA system to identify and respond to activities immediately, rather than relying on post-processing of recorded data. Real-time processing typically involves techniques like sliding windows, feature extraction, and classification performed on the incoming sensor data streams.

The present invention is directed to the educational arena. However, applications of HAR AI may also be found in healthcare, fitness, Smart Homes, security and workplace safety. In healthcare, an application of HAR AI may be found in monitoring patient activities to assess mobility and detect falls. In Smart Homes, an application of HAR AI may be found in automating home systems based on resident activities, like adjusting lighting or heating. In security, an application of HAR AI may be found in surveillance systems used in recognizing suspicious activities. In workplace safety, an application of HAR AI may be found in monitoring compliance with safety protocols in industrial environments.

In fitness, an application of HAR AI may be found in tracking exercise routines and providing feedback to the user. An example of HAR AI in fitness tracking is disclosed herein. The steps comprise data collection, data preprocessing, feature extraction, model training, model evaluation and deployment. In the Data Collection step, wearable devices collect accelerometer and gyroscope data as a user performs different exercises. In the Data Preprocessing step, the sensor data is normalized and noise in the sensor data is removed. In the Feature Extraction step, data features are extracted such as acceleration magnitude, angular velocity, and signal patterns that correspond to specific exercises. In the Model Training step, a deep learning model is trained using labeled data where each exercise type is identified. In the Model Evaluation step, the model is tested with unseen data to evaluate its performance. Lastly, in the Deployment step, the model is integrated into a fitness app that tracks user activities in real-time, providing feedback and logging exercises.

To implement HAR AI, the following steps may include: 1) data collection, 2) data preprocessing, 3) feature extraction, 4) model training, 5) model evaluation, 6) deployment and 7) Real-Time Activity Recognition.

In the Data Collection step, data is gathered from relevant sources. In a smart home, this might include video from cameras and data from motion sensors.

In the Data Preprocessing step, data is cleaned and preprocessed. Data may normalization data, noise reduction data, and synchronization data (for multi-sensor data).

In the Feature Extraction step, relevant features of the data are extracted that describe the desired activities. This could involve detecting key points on the human body, segmenting movement patterns, or analyzing sensor signal variations.

In the Model Training step, labeled datasets are used to train the AI model. Supervised learning techniques are commonly used, where the model learns to associate features with specific activities.

In the Model Evaluation step, the model is evaluated using metrics like accuracy, precision, recall, and F1-score. Cross-validation may also be used to ensure the model generalizes well to new data.

In the Deployment step, the trained model is deployed in the target environment. This might involve integrating the model with a smart home system, a fitness app, or a surveillance system. Real-time Activity Recognition may comprise implementing real-time processing capabilities to recognize activities as they happen, providing immediate feedback or triggering automated responses.

As seen in FIG. 2, the digital camera is small and non-obtrusive. The digital camera is equipped with a memory card. However, it may also be connected to a USB storage drive to provide increased data storage. In FIG. 2, the digital camera captures a photo or video of the students in the classroom and identifies the multiple intelligence(s) in the photo. For students X, Y and Z in FIG. 2, the multiple intelligence identified is a spatial multiple intelligence.

For each student, the computer program the MIRA System generates a list of multiple intelligences for each student. The computer program then determines which multiple intelligence(s) need to be supplemented and provides a list of recommended activities to the teacher for each student. The list of recommended activities are categorized according to a particular multiple intelligence. These multiple intelligences are spatial, kinesthetic, logical, linguistic, musical, naturalistic, interpersonal and intrapersonal.

### Determining A Multiple Intelligence Deficiency

To identify a multiple intelligence deficiency, the digital camera takes data from the beginning of the school year or any time determined by the user. Each student has a portfolio of data which includes the type of multiple intelligence activities done in the class (visual-spatial, linguistic-verbal, logical-mathematical, body-kinesthetic, musical, interpersonal, intrapersonal or naturalistic multiple intelligence) followed by how many times the student applies these types of activities.

FIG. 3 exemplifies this process of determining a multiple intelligence deficiency by the MIRA System. FIG. 3 provides data taken from the two different time points, with the initial data being the control. The numbers in FIG. 3 provide the quantity of the specified type of activities done by student X in the class. The numbers may be in the form of a percentage or of a value. As shown in exemplary FIG. 3, the control photo was taken on Nov. 1, 2023 for Student X. Data taken from the control photo of Student X indicates activity from the spatial, kinesthetic, and logical multiple intelligences. The other data in FIG. 3 were data from taken from Dec. 11, 2023 for Student X. Data taken Dec. 11, 2023 indicates activity from the spatial, linguistic, kinesthetic, and logical multiple intelligences. As seen in the December 11 data, Student X exhibited a linguistic multiple intelligence that was not observed in the control.

The computer program of the MIRA System saves the data from the digital camera and identifies at least one multiple intelligence that needs to be supplemented for each student. Data taken from the control photo of FIG. 3 indicates activity from the spatial, kinesthetic, and logical multiple intelligences. This generates a prediction that linguistic, musical, naturalistic, interpersonal or intrapersonal multiple intelligences may be deficient. The MIRA System of the present invention then proposes activities to enhance a student's linguistic, musical, naturalistic, interpersonal or intrapersonal multiple intelligences. This proposal of multiple intelligence activities is the recommendation module of the MIRA System.

### Recommendation Module of the MIRA System

The computer program of the MIRA System recommends activities on each requested multiple intelligence and each skill based on objectives taught in schools. The following are activities for each multiple intelligence for an exemplary Plant Learning Module of of the MIRA System for students in grades 1, 2 and 3. Examples of the activities suggested by the Recommendation Module of the MIRA System may be provided to the teacher in the form of Activity Cards, which are available in hard copy or virtual format.

A sample Activity Card for the spatial multiple intelligence from the MIRA System provides the materials needed and a suggested procedure for implementing the activities. In an Introduction to Seeds activity for the spatial multiple intelligence, the teacher begins by discussing the importance of seeds and their role in the plant life cycle and explains that seeds come in a wide variety of shapes, sizes, and colors, and each type of seed is unique.

In a Seed Exploration activity for the spatial multiple intelligence, the teacher provides the students with a selection of different seeds and encourages them to examine the seeds closely. The teacher then asks them to observe the unique characteristics of each seed, such as its shape, color, texture, and size. The students and the teacher discuss the different plants that the seeds come from and how they contribute to the diversity of the natural world.

In a Seed Mosaic Design activity for the spatial multiple intelligence, the teacher gives each child a piece of colored cardstock or construction paper to use as a canvas. The teacher then invites the students to start planning their seed mosaic design. Finally, the teacher encourages them to think about how they can use the different seeds to create patterns, shapes, or abstract designs on their paper.

In a Seed Placement activity for the spatial multiple intelligence, the teacher demonstrates how to apply a small amount of glue to the back of each seed and then carefully places the seed onto the paper. The teacher reminds the students to pay attention to the orientation and arrangement of the seeds to create their desired design. Finally, the teacher suggests that they can overlap or layer the seeds to add depth and texture to their artwork.

In a Seed Identification activity for the spatial multiple intelligence, the students work on their seed mosaics, and label or identify the different types of seeds they are using. The teacher provides them with a reference list or guide to the seeds, or has the students write the names of the seeds directly on their artwork.

In an Exploring Seed Diversity activity for the spatial multiple intelligence, the teacher discusses the unique characteristics of the different seeds and the plants they come from. The teacher encourages the students to observe the varying shapes, sizes, and colors of the seeds and how they can be used to create diverse and visually interesting designs. The teacher finally highlights the diversity of seeds and how they all play a crucial role in the growth and reproduction of plants.

In a Reflection and Sharing activity for the spatial multiple intelligence, the students share their mosaic creations with the group. The teacher encourages the students to talk about the design choices they made and the types of seeds they used. The teacher facilitates a discussion about the importance of seeds in the natural world and how the activity helped them learn about the diversity of plants. Finally, the teacher creates a gallery or exhibition to showcase the students'seed mosaics and the information they learned.

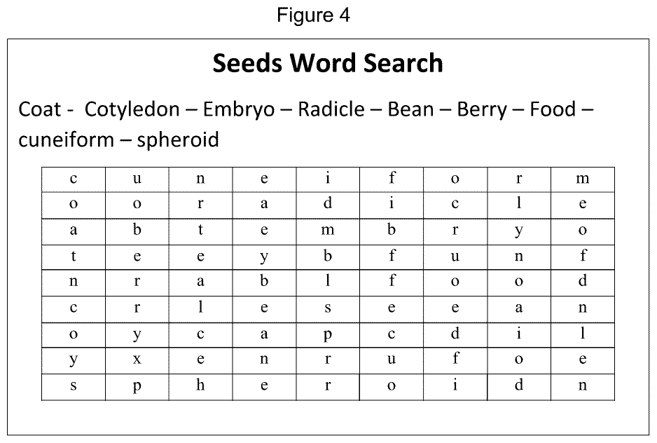

A sample Activity Card for the linguistic multiple intelligence from the MIRA System provides the materials needed and a suggested procedure for implementing the activities. A sample Seeds Word Search Puzzle may be found in FIG. 4. In the Seeds Word Search activity for the linguistic multiple intelligence, the teacher begins by discussing the importance of seeds and their diverse characteristics. Then the teacher explains to the students that they will be working on a word search puzzle that features seed-related vocabulary words. Finally, the teacher emphasizes that the word search puzzle will include words related to the colors, shapes, sizes, and types of seeds.

In a Searching for the Vocabulary Words activity for the linguistic multiple intelligence, the teacher instructs the students to carefully examine the word search puzzle and try to locate the seed-related vocabulary words. Then the teacher encourages the students to work together, sharing their knowledge and strategies to find the words. The teacher reminds the students to look for the words in different directions, including horizontally, vertically, diagonally, and even backwards. If needed, the teacher provides a list of the seed vocabulary words that are hidden in the puzzle.

In a Discussing and Sharing Findings activity for the linguistic multiple intelligence, the teacher facilitate a class discussions after the class has complete the word search. The teacher asks volunteers to share the words they found and provide any interesting observations or insights about the seed vocabulary. The teacher encourages the students to ask questions or share their experiences in completing the word search. Finally, the class discusses the significance and relevance of the seed-related vocabulary words.

In a Reinforcing Seed Knowledge activity for the linguistic multiple intelligence, the teacher engages the students in a discussion about seeds. The teacher asks them to share their knowledge about the different seed characteristics, such as colors, shapes, sizes, and types. The teacher provides additional information or clarification about any seed-related concepts that the students may have questions about. Lastly, the teacher encourages the students to share their own experiences or personal connections with seeds.

A sample Activity Card for the logical multiple intelligence from the MIRA System provides the materials needed and a suggested procedure for implementing the activities. In an Introduction to Seed Measurement activity, the teacher begins by discussing the importance of seeds and their diverse characteristics. The teacher then explains to the students that they will be measuring and comparing the physical properties of different seed types. Lastly, the teacher demonstrates the proper use of rulers and calipers, and discuss the importance of accurate measurements.

In a Seed Exploration and Measurement activity for the logical multiple intelligence, the teacher provides each student or group of students with a variety of seed samples. The teacher instructs the students to carefully observe the seeds and use the rulers or calipers to measure the following dimensions: Length (the longest part of the seed), Width (the widest part of the seed), and Height (the thickness or depth of the seed). The teacher encourages the students to record their measurements on the data collection worksheets or in their notebooks. The teacher suggests that the students use magnifying glasses or microscopes to observe the seeds more closely and notice any unique features or patterns.

In a Comparing Seed Characteristics activity for the logical multiple intelligence, the students collect the measurements for the different seed types and compare the data. The teacher then prompts the students to identify any similarities and differences in the seed dimensions. The teacher encourages the students to discuss their observations and try to find patterns or trends in the seed characteristics. Finally, the teacher facilitates a class discussion where students share their findings and insights.

In a Seed Classification and Categorization activity for the logical multiple intelligence, the teacher guides the students in categorizing the seeds into groups or types based on the measurements and observations of the students. The students discuss the criteria they used to group the seeds, such as size, shape, or other distinctive features. The teacher encourages the students to consider how the seed characteristics might be related to the plant's function or adaptations.

In a Reflection and Conclusion activity for the logical multiple intelligence, the teacher invites the students to share their overall experiences and learning during the seed measurement activity. The teacher asks the students to reflect on the importance of understanding seed diversity and how the measurements they collected can provide insights into the seeds. Finally, the class discusses any further questions or curiosities the students have about seeds and their characteristics.

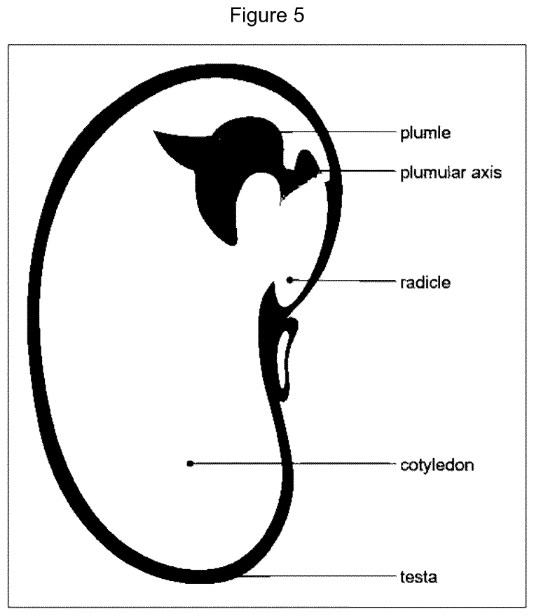

A sample Activity Card for the kinesthetic multiple intelligence from the MIRA System provides the materials needed and a suggested procedure for implementing the activities. FIG. 5 is a schematic of a seed provided by the MIRA System. In an Introducing the Seed Dissection Activity for the kinesthetic multiple intelligence, the teacher begins by discussing the importance of seeds and their role in plant reproduction. The teacher explains to the students that they will be exploring the different parts of a seed through a hands-on activity. Finally, the teacher highlights the significance of understanding seed structure and function.

In a Balloon Labels activity for the kinesthetic multiple intelligence, the teacher distributes balloons to the students or groups. The teacher instructs the students to write the names of the various seed parts on the balloons using the permanent markers. The seed parts to be labeled may include: the Seed coat (testa), the Cotyledon(s), the Embryo, the Radicle, the Plumule, and the Endosperm (if applicable).

In a Scattering the Balloon Labels activity for the kinesthetic multiple intelligence, the teacher scatters the labeled balloons around a designated area in the classroom or outdoor space. The teacher ensures that the area is large enough for the students to move around and access the balloons.

In a Seed Dissection and Matching activity for the kinesthetic multiple intelligence, the teacher directs the students to the large seed diagram or model displayed in the classroom. The teacher instructs the students to pop the balloons and then match the seed part labels to the corresponding structures on the diagram or model. Finally, the teacher encourages the students to use the seed dissection tools (if available) to carefully explore the balloon “seeds” and observe the different parts.

In a Class Discussion and Reflection activity for the kinesthetic multiple intelligence, the teacher facilitates a class discussion about the seed dissection activity. The teacher asks the students to share their observations, insights, and any challenges they encountered. The teacher encourages the students to discuss the importance of understanding seed anatomy and how it relates to the plant's life cycle. Finally, the teacher addresses any questions or misconceptions the students may have about the seed parts and their functions.

A sample Activity Card for the interpersonal multiple intelligence from the MIRA System provides the materials needed and a suggested procedure for implementing the activities. In an Introduction to Seed Anatomy activity for the interpersonal multiple intelligence, the teacher begins by discussing the importance of seeds and their role in plant reproduction. The teacher provides a brief overview of the different parts of a seed and their functions. Lastly, the teacher emphasizes the significance of understanding seed structure and how it relates to the plant's life cycle.

In a Seed Exploration and Labeling activity for the interpersonal multiple intelligence, the teacher instructs teams of students to closely observe the seed diagram or model and identify the various parts. The teacher provides the teams with sticky notes or labels and pens/markers. The teacher asks the teams to carefully label the different seed parts on the diagram or model. Lastly, the teacher encourages the teams to use the seed dissection tools (if available) to examine the seed structure more closely.

In a Team Discussion and Presentation activity for the interpersonal multiple intelligence, the teacher asks the teams of students to discuss the functions of the different seed parts. The teacher prompts the teams to consider how the seed structure and characteristics relate to the plant's growth and development. Finally, the teacher invites each team to present their labeled seed diagram or model to the class, highlighting the different parts and their functions.

In a Class Discussion and Reflection activity for the interpersonal multiple intelligence, the teacher facilitates a class discussion, allowing the teams to share their insights and observations. The teacher encourages the students to ask questions and engage in a dialogue about the seed anatomy and its significance. Finally, the teacher summarize the key takeaways from the activity, reinforcing the importance of understanding seed structure and function.

A sample Activity Card for the intrapersonal multiple intelligence from the MIRA System provides the materials needed and a suggested procedure for implementing the activities. In an Introduction to the Seed Exploration activity for the intrapersonal multiple intelligence, the teacher begins by discussing the importance of seeds in the natural world and their role in plant reproduction and human/animal sustenance. The teacher highlights the diversity of seed types, shapes, colors, and characteristics. Finally the teacher explains to the students that they will be engaging in a gratitude reflection activity focused on the wonders of seeds.

In a Seed Exploration and Observation activity for the intrapersonal multiple intelligence, the teacher distributes the collection of different seed types to the students. The teacher encourages the students to closely observe the seeds using their senses (sight, touch, smell, etc.) and the magnifying glasses or hand lenses (if available). Finally, the teacher prompts the students to notice the unique features of each seed, such as its shape, texture, color, and size.

In a Gratitude Reflection activity for the intrapersonal multiple intelligence, the teacher provides the students with a gratitude journal or paper and invite them to write a reflection on the seeds they have explored. The teacher prompts the students to consider the following questions: What seed characteristics did you find most fascinating or beautiful? How do the seeds remind you of the diversity and wonder of the natural world? In what ways do seeds sustain and support life on our planet? What are you most grateful for when it comes to the role of seeds in the ecosystem?

In a Sharing and Discussion activity for the intrapersonal multiple intelligence, the teacher invites the students to share their gratitude reflections with the class (voluntarily). The teacher encourages the students to listen to and appreciate each other's perspectives and insights. Finally, the teacher facilitates a class discussion, highlighting the common themes and unique observations that emerge from the reflections.

In a Closing and Wrap-up activity for the intrapersonal multiple intelligence, the teacher summarizes the key takeaways from the seed exploration and gratitude reflection activity. The teacher emphasizes the importance of cultivating a sense of appreciation and wonder for the natural world, particularly the life-sustaining qualities of seeds. Finally, the teacher encourages the students to continue their gratitude practice and apply it to other aspects of the natural environment.

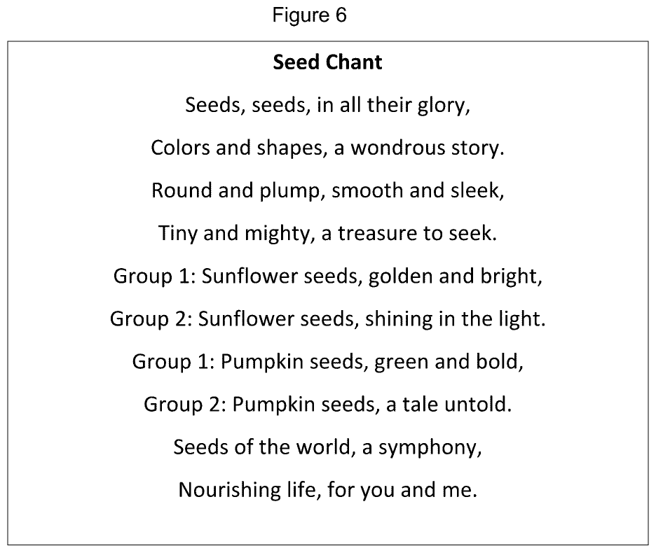

A sample Activity Card for the musical multiple intelligence from the MIRA System provides the materials needed and a suggested procedure for implementing the activities. FIG. 6 is an example of a Seed Chant. In an Introduction to Seed Exploration activity for the musical multiple intelligence, the teacher begins by discussing the importance of seeds in the natural world and their diverse characteristics. The teacher encourages the students to closely observe the seeds using their senses (sight, touch, smell, etc.) and the magnifying glasses or hand lenses (if available). Lastly, the teacher prompts the students to notice the unique features of each seed, such as its shape, texture, color, and size.

In a Seed Chant Brainstorming activity for the musical multiple intelligence, the teacher divides the class into small groups of 3-5 students. The teacher assigns each group a specific seed type or characteristic (e.g., sunflower seeds, round seeds, small seeds, etc.). The teacher then instructs the groups to discuss and brainstorm how they can represent their assigned seed through a chant or repetitive vocal pattern. The teacher encourages the groups to consider the following: What vocal techniques (e.g., low/high tones, slow/fast tempo, call-and-response, harmonies) can they use to capture the essence of their seed? How can they incorporate the specific colors, shapes, and sizes of their seed into the chant? What rhythmic patterns or vocal sounds (e.g., hums, whispers, percussive sounds) can they explore?

In a Seed Chant Development activity for the musical multiple intelligence, the teacher provides the groups with time to collaborate and develop their seed chants. The teacher encourages the students to experiment with different vocal techniques and to build upon each other's ideas. Lastly, the teacher reminds the groups to consider how their chant can be coordinated and blended with the other groups'chants.

In a Chant Sharing and Reflection activity for the musical multiple intelligence, the teacher invites each group to perform their seed chant for the class. After each performance, the teacher facilitates a brief discussion, encouraging the class to share their observations and reflections on the chant. Finally, the teacher prompts the students to consider the following questions: How well did the chant capture the essence of the seed? What vocal techniques or elements were most effective in representing the seed's characteristics? How did the chant make you feel about the natural world and the diversity of seeds?

In a Collaborative Chant activity for the musical multiple intelligence, the teacher brings the class together to create a collaborative seed chant. The teacher guides the students in combining elements from the individual group chants to form a cohesive, multi-layered chant. The teacher encourages the students to experiment with harmonies, call-and-response patterns, and other vocal techniques to enhance the collaborative chant.

In a Closing and Reflection activity for the musical multiple intelligence, the teacher leads a discussion, asking the students to share their overall thoughts and experiences from the activity. The teacher emphasizes the importance of developing a sense of appreciation and reverence for the natural world, particularly the diversity and significance of seeds. Lastly, the teacher encourages the students to continue exploring and expressing their connection to the environment through creative vocal expressions.

A sample Activity Card for the naturalistic multiple intelligence from the MIRA System provides the materials needed and a suggested procedure for implementing the activities. In a Seed Exploration and Observation activity for the naturalistic multiple intelligence, the teacher begins by presenting the students with a variety of seed samples and encourage them to observe the unique characteristics of each seed. The teacher then prompts the students to use their senses (sight, touch, smell) to explore the seeds, noticing their shapes, textures, and patterns. Encourage the use of magnifying glasses or hand lenses (if available) to closely examine the intricate details of the seeds. Lastly, the teacher facilitates a discussion, asking the students to share their observations and any insights they have about the seeds.

In a Leaf Print Preparation activity for the naturalistic multiple intelligence, the teacher introduces the concept of leaf printing, explaining that the students will be using seeds to create their own unique leaf-inspired prints. The teacher then demonstrates how to press the seeds onto an ink pad or acrylic paint, and then transfer the imprint onto paper or fabric. Lastly, the teacher encourages the students to experiment with different techniques, such as overlapping seeds, using partial seed imprints, or creating patterns.

In a Seed Printing activity for the naturalistic multiple intelligence, the teacher provides the students with their choice of paper or fabric and invites them to begin creating their leaf prints. The teacher then encourages the students to thoughtfully arrange the seeds on their surface, considering the composition and the overall design. The teacher reminds the students to gently press the seeds onto the surface and lift them carefully to avoid smudging. Lastly, the teacher observes the students as they work, offering guidance and support as needed.

In a Sharing and Reflection activity for the naturalistic multiple intelligence, the teacher invites the students to share their finished leaf print creations with the class. The teacher facilitates a discussion, encouraging the students to share their observations and insights about the process. The teacher prompts the students to consider the following questions: What unique characteristics of the seeds did you observe and incorporate into your leaf prints? How did the different seed shapes, textures, and patterns influence your artistic choices? What did you discover about the natural world through this activity?

Based on the data obtained by the MIRA System on the types of activities and how many times these activities were applied for each student, the Recommendation Module of the MIRA System provides an activity analysis for each student and determines if there is a deficiency in a specific type of activity. To determine a deficiency, the MIRA System 1) analyzes the data, 2) detects a deficiency, 3) provides feedback and 4) lastly interprets and reassesses the data. This reassessment of the data comprises a step of creating a feedback loop to continuously improve the machine learning models based on new data and prediction outcomes.

The first step of the deficiency analysis is Data Analysis (1). In this step, the MIRA System conducts a frequency analysis wherein it analyzes how often each child engages in activities corresponding to each type of intelligence. For instance, the MIRA System counts the number of times a child engages in logical-mathematical activities versus musical activities. After the frequency analysis, the MIRA System conducts a diversity analysis, wherein the MIRA System: examines the variety of activities within each intelligence category. A broad range of activities may indicate a well-rounded development in that intelligence type.

The second step of the deficiency analysis is Deficiency Detection (2). In this step, the MIRA System sets the threshold for what it considers a deficiency and identifies patterns in the data. In the Threshold Setting step, the MIRA System sets thresholds for what constitutes a deficiency. For example, if a child engages in logical-mathematical activities less than 20% of the time compared to their peers, it may indicate a potential deficiency. After the Threshold Setting step, the MIRA System identifies patterns in the data that suggest a lack of engagement or proficiency in specific multiple intelligences. Clustering algorithms may be used, for example, to detect outliers and anomalies.

The third step of the deficiency analysis is Feedback and Intervention (3). In this step, the MIRA System personalizes feedback and provides an intervention program, if needed. In the Personalized Feedback step, the MIRA System provides detailed feedback to educators and parents, highlighting areas where the student is excelling and where the student might need more support. In the Intervention Programs, the MIRA System suggests targeted activities and interventions to help the child develop in areas where they are deficient. For example, if a child shows low engagement in body-kinesthetic activities, the MIRA System recommends more kinesthetic activities related to physical play or sports.

The last step of the deficiency analysis is Reassessment and Adjustment (4). In this step, the MIRA System conducts regular reassessments to monitor progress and adjusts the intervention strategies accordingly. The MIRA System may also adaptively learn, wherein the ongoing data is used to continually refine and personalize the learning and development plan for each student.

### Implementing MIRA AI Program to Identify A Multiple Intelligence Deficiency

Once a multiple intelligence has been identified, the Deficiency Analysis is implemented in the MIRA AI Program. The first step is to create a data pipeline, the next step is to train the model and the last step is to create a user-friendly dashboard for users to access reports and data analyses. In the first step, the MIRA System creates a data pipeline that automates the collection, preprocessing, and analysis of activity data. Cloud storage and computing resources may be used to handle large volumes of data efficiently. In the second step, the MIRA System trains models specifically designed to recognize and classify activities related to different intelligences.

A user-friendly dashboard for educators and parents may be provided to continuously visualize its data and insights. This dashboard may include customizable reports that can be generated on demand to track a student's progress over time. The dashboard may also include results from a Woodcock scale or any other accurate cognitive scale to demonstrate the effective intervention of MIRA system on the cognitive abilities of the students.

Example 5 recommends activities for a Plants (Cycle 1.1 Shapes, Needs and Benefits) module. The activities provided in Example 5 are categorized for each multiple intelligence (spatial, kinesthetic, logical, linguistic, musical, naturalistic, interpersonal or intrapersonal).

Example 6 recommends activities for a Plants (Cycle 1.2 Germination of Seeds) module. The activities provided in Example 6 are categorized for each multiple intelligence (spatial, kinesthetic, logical, linguistic, musical, naturalistic, interpersonal or intrapersonal).

Example 7 recommends activities for a Plants (Cycle 1.3 Components of a Garden) module. The activities provided in Example 7 are categorized for each multiple intelligence (spatial, kinesthetic, logical, linguistic, musical, naturalistic, interpersonal or intrapersonal).

Example 8 recommends activities for a Plants (Cycle 1.4 Taking Care of a Garden) module. The activities provided in Example 8 are categorized for each multiple intelligence (spatial, kinesthetic, logical, linguistic, musical, naturalistic, interpersonal or intrapersonal).

Example 9 recommends activities for a Plants (Cycle 1.5 Seasonal Plants and Green House Effect) module. The activities provided in Example 9 are categorized for each multiple intelligence (spatial, kinesthetic, logical, linguistic, musical, naturalistic, interpersonal or intrapersonal).

Example 10 recommends activities for a Plants (Cycle 1.6 Main Parts of A Green Plant) module. The activities provided in Example 10 are categorized for each multiple intelligence (spatial, kinesthetic, logical, linguistic, musical, naturalistic, interpersonal or intrapersonal).

Example 11 recommends activities for a Plants (Cycle 1.7 Components of Habitat (desert plant-water plant-forest plant)) module. The activities provided in Example 11 are categorized for each multiple intelligence (spatial, kinesthetic, logical, linguistic, musical, naturalistic, interpersonal or intrapersonal).

Recommended resources from the computer program are based on objectives for the teachers to help them apply different types of multiple intelligences.

In one embodiment, the presence of the camera is non-invasive. For example, the digital camera may be a webcam pointing to the students of interest and located near the ceiling of the classroom. As used herein, a classroom is any environment where students are taught. A classroom may be in building, in a remote environment such as a home school, or outside of a building. Where the classroom is outside of a building, the digital camera may be part of laptop.

In one embodiment, the multiple intelligence is spatial, kinesthetic, logical, linguistic, musical, naturalistic, interpersonal or intrapersonal.

In a further embodiment, the spatial multiple intelligence is verbal communication, spatial visualization, spatial reasoning, pattern recognition, design, artistic expression, navigation or a combination thereof.

In another embodiment, the linguistic multiple intelligence is verbal communication, written communication, reading comprehension, wordplay, storytelling or a combination thereof.

In a further embodiment, the logical multiple intelligence is logical reasoning, deductive reasoning, problem-solving, mathematical operations, data analysis or a combination thereof.

In a further embodiment, the body or kinesthetic multiple intelligence is body control, fine motor skills, physical expression, athletic ability, body language, kinesthetic learning or a combination thereof.

In a further embodiment, the musical multiple intelligence is musical perception, musical memory, instrumental proficiency, vocal proficiency, musical composition, music theory, musical performance or a combination thereof.

In a further embodiment, the naturalistic multiple intelligence is observational skills, ecological knowledge, environmental stewardship, outdoor skills, agricultural knowledge, geographical knowledge, environmental design, conservation biology or a combination thereof

In a further embodiment, the interpersonal multiple intelligence is communication, collaboration, leadership, networking, social awareness, conflict resolution, cultural competence or a combination thereof.

In a further embodiment, the intrapersonal multiple intelligence is self-awareness, self-reflection, goal setting, metacognition, mindfulness, autonomy, resilience or a combination thereof.

It is to be understood that the foregoing general description and the following detailed description are exemplary and explanatory only, and are not restrictive of any subject matter claimed.

Headings are used solely for organizational purposes, and are not intended to limit the invention in any way. Unless otherwise defined, all technical and scientific terms used herein have the same meaning as is commonly understood by one of skill in the art to which the inventions belong. All patents, patent applications, published applications and publications, websites and other published materials referred to throughout the entire disclosure herein, unless noted otherwise, are incorporated by reference in their entirety for any purpose. Although any methods and materials similar or equivalent to those described herein can be used in the practice or testing of the present invention, the preferred methods are described.

In a particular aspect, some examples of the spatial multiple intelligence are cut-outs, Venn diagrams, sticky board, scavenger hunt, diorama, memory game, flashcards, and nature walks.

In a particular aspect, some examples of the linguistic multiple intelligence are writing and telling short stories, developing fact cards, spelling bees and community events.

In a particular aspect, some examples of the logical/mathematical multiple intelligence are cause and effect diagrams, development of a logical conclusion, preparing a decision-making matrix, and analysis of experimental data.

In a particular aspect, some examples of the body/kinesthetic multiple intelligence as related to Plants are Flower Pressing, Soil Texture, preparation of Soil Layers, Composting, Pollution Cleanup, a Plant Growth Field Trip, observation of the sun's path during the day, herb identification, harvesting plants, blending herbal teas, propagating plants, drying herbs, foraging the cooking plants, making herbal salves, Fruit and Vegetable Carving, Medicinal Herb Identification, Herb Sachet Making and Herbal Bath Salt Making.

In a particular aspect, some examples of the musical multiple intelligence are a Dance Party, listening to Sounds of Water, Musical Storytelling, and singing songs.

In a particular aspect, some examples of the naturalistic multiple intelligence are planting seeds, Botanical field trip, collecting rain water to water plants, identifying Soil Types, Water Purification, pumping water using solar energy, Desert field trip, field trip to a Seed Bank, a Composting Project, Soil Microorganism Study, Plant Respiration Demonstration and a Cooking Workshop utilizing foraged plants.

In a particular aspect, some examples of the interpersonal multiple intelligence are a plant Potluck Party, a Recipe Swap, a Smoothie Tasting, a Community Garden Project, a Food Preservation Workshop, a Grocery Shopping Tour, a Food Sharing Circle, a Kitchen Garden Project, a Seasonal Cooking Class, a Food Waste Reduction Workshop, a Local Foraging Expedition, a Plant-Based Ice Cream Social, a Sustainable Eating Panel Discussion and a Poster session.

In a particular aspect, some examples of an intrapersonal multiple intelligence with respect to plants are having a Personal Mantra, preparing a Vision Board, Mindful Meditation, writing a Letter to Your Self, Personal Photography, preparing Mission Statements, writing a Letter to a Seed and reading articles about plants and the environment.

### EXAMPLES

The present invention is further described by the following non-limiting examples, which further illustrate specific aspects of the invention, and are not intended to, nor should they be interpreted to, limit the scope of the invention in any respect.

### Example 1. Camera System

The camera system comprises any digital camera (as shown in FIG. 2 and FIG. 3). Any digital camera will be coded using human activity recognition AI. As shown in FIG. 2, the camera is small and non-obtrusive.

### Example 2. Computer Program

The computer program, controlling the digital camera and saving the data from the camera, is programed using Delphi 11.3 and Python. Some of the key features in Delphi 11.3 include: 1) Improved integration with popular open-source libraries and frameworks, 2) Better integration with popular database management systems and 3) Easier deployment and hosting of Delphi-developed applications in the cloud. Python also provides strong support for Artificial Intelligence (AI) and Machine Learning (ML) applications. Python's strong support for AI and ML may be found in its libraries such as TensorFlow, Keras, and PyTorch. Other programs may also be used to attain the same function. However, Delphi 11.3 and Python are preferred.

The documents provided by the MIRA System are structured using HTML. HTML (Hypertext Markup Language) is the standard markup language used to create and structure web pages. HTML provides the basic building blocks for creating the content, layout, and structure of web pages. One of the key features of HTML is its ability to create hyperlinks, which allow users to navigate between web pages by clicking on links. Other programs may also be used to attain the same function. However, HTML is preferred.

Examples of documents provided by the MIRA System are science-based multiple intelligence activities including pictures, videos, sheets, games, materials and procedure, and scripts, for students in grades 1 thru 6. However, the documents may also be directed to students in other grades, other languages, social studies, and any other subjects taught in non-elementary school grades.

### Example 3. Determining Control Activity

To identify a multiple intelligence deficiency, the camera first takes data from the beginning of the school year or any time determined by the user. These photos are the control photos. As shown in exemplary FIG. 3, the control photo was taken on Nov. 1, 2023 for Student X. Data taken from the control photo indicates activity from the spatial, kinesthetic, and logical multiple intelligences.

### Example 4. Recognizing Deficient Multiple Intelligence

The computer program saves the data from the camera and identifies a multiple intelligence that needs to be supplemented for each student. Data taken from the control photo of FIG. 3 indicates activity from the spatial, kinesthetic, and logical multiple intelligences. This suggests that linguistic, musical, naturalistic, interpersonal or intrapersonal multiple intelligences may be deficient. If requested, the MIRA System of the present invention proposes activities through its Recommendation Module to enhance a student's linguistic, musical, naturalistic, interpersonal or intrapersonal multiple intelligences.

### Example 5. Plants (cycle 1.1 Shapes, Needs and Benefits) Module

One example of an application of the present invention's camera/computer program system is as applied to the Plants (Cycle 1.1 Shapes, Needs and Benefits) module is shown below. Proposed activities from the Recommendation Module of the MIRA System are provided for each multiple intelligence (spatial, kinesthetic, logical, linguistic, musical, naturalistic, interpersonal or intrapersonal).

### Activities for the Spatial Multiple Intelligence for Cycle 1.1.

Exemplary proposed activities are:
1) The teacher takes photos for different plants and stick them on the class board.
2) The teacher conducts a soil compaction simulation activity to demonstrate how heavy machinery and foot traffic impact soil and plant growth.
3) The class designs a poster illustrating indoor plant air quality importance and tips for improving circulation.
4) The class observes shadow movement throughout the day to understand light pattern changes and their impact on growth.
5) The teacher captures visually appealing images of plant-based dishes, emphasizing the artistry and beauty of plant-based food.
6) The teacher produces plant-based cheeses using nuts, seeds, or other plant-based ingredients, showcasing the versatility of plant-based alternatives.
7) The teacher cuts the needs of the plant and pastes them.

### Activities for the Linguistic Multiple Intelligence for Cycle 1.1.

Exemplary proposed activities are:
1) The teacher writes a step by step guide on providing optimal conditions of water (or any need) for seed planting.
2) The class listens to a short story about a seed's journey to find water and warmth, then answers questions based on the story.
3) The teacher designs a set of “Did You Know?” fact cards about plants needs and benefits.
4) The class writes a letter to a local government official or environmental organization expressing concerns about the effect of pollution on plants (water pollution, soil pollution, air pollution).
5) The teacher play a spelling bee or a vocabulary quiz centered around plants needs and benefits terms.
6) The teacher hosts a community event like a gardening workshop or tree planting day or earth day to educate and improve local green spaces.

### Activities for the Logical Multiple Intelligence for Cycle 1.1.

Exemplary proposed activities are:
1) The teacher creates a cause and effect diagram illustrating the relationship between water, warmth, and seed growth.
2) Students analyze data on seed growth under different conditions to draw logical conclusions.
3) The teacher shows a decision-making matrix helping students determine the best actions for providing plans needs based on various scenarios.
4) The teacher conducts a simulation activity where students manipulate virtual variables like water quantity and temperature to observe effects on seed growth.
5) The teacher has students observe and compare growth and health of outdoor and indoor potted plants to recognize air's role in plant development.
6) The teacher conduct an air quality testing experiment exposing plants to different pollutants to observe impacts on growth and wellbeing.
7) The teacher demonstrates nyctinasty in a sensitive plant and explains sunlight's influence on leaf movement, allowing students to observe and interact with the plant. In plant biology, nyctinasty is the circadian rhythm-based nastic movement of higher plants in response to the onset of darkness, or a plant “sleeping”.
8) The teacher introduces the concept of plant care by discussing the basic needs of plants, such as water, sunlight, and air.
9) The teacher helps students create a simple chart or checklist to track the care of plants in the classroom. They can take turns watering, observing, and maintaining the plants to ensure their health and beauty.
10) The teacher divides students into teams and give them a limited budget for a plant-based grocery shopping challenge, encouraging them to find affordable and nutritious options.
11) Students observe and compare the growth of a plant on different conditions showing them the results in bar-graph form. After comparing and results, students derive out a conclusion concerning the needs of the specified plant.

### Activities for the Kinesthetic Multiple Intelligence for Cycle 1.1.

Exemplary proposed activities are:
1) The teacher teaches students how to press flowers by placing them between sheets of paper and pressing them in a heavy book. After a few weeks, when the flowers are dried and flattened, they can be used for various decorative purposes, such as making bookmarks or adorning handmade cards.
2) The teacher conducts a soil texture test to determine soil composition and its implications on plant growth.
3) The teacher organizes a soil digging activity for students to explore layers and variations.
4) The teacher sets up a composting station for students to learn about soil fertility improvement.
5) The teacher engages in a soil pollution cleanup activity to emphasize soil, water and air cleanliness importance.
6) The teacher guides students through a breathing exercise mimicking plant respiration with air.
7) The teacher sets up a plant growth experiment in different light conditions for observation.
8) The teacher experiments with indoor plant placements to find optimal light conditions.
9) The teacher organizes a field trip for students to explore plant environments and their needs.
10) Students observe and record the sun's path throughout the day to understand light changes.
11) The teacher sets up a sensory station with various herbs and plants. Students can touch, smell, and taste them to understand their different uses.
12) The teacher organizes a session where students can harvest fruits, vegetables, or herbs, highlighting their role as food or medicine.
13) The teacher provides different dried herbs and flowers for students to create their own herbal tea blends, experiencing the aromas and flavors.
14) The teacher sets up a perfume making station with essential oils and floral extracts. Students can create their own custom scents.
15) The teacher demonstrates how to extract gel from Aloe Vera leaves, allowing students to practice the process themselves.
16) The teacher shows students different methods of plant propagation, such as stem cuttings or root division, allowing them to try it themselves.
17) The teacher instructs students on how to dry herbs for culinary or medicinal purposes. They can practice the drying process with selected herbs.
18) The teacher conducts a hands-on cooking class using plant-based ingredients, emphasizing their nutritional value and culinary versatility.
19) The teacher teaches students how to make herbal salves using infused oils and beeswax. The students can create their own soothing balms.
20) The teacher provides fruits and vegetables for students to practice carving
techniques, highlighting the beauty and creativity of plant-based foods.
21) The teacher arranges a scavenger hunt where students search for specific medicinal herbs, learning to identify them by their characteristics.
22) The teacher conducts a workshop on creating natural skincare products using plant-based ingredients, such as face masks or body scrubs.
23) The teacher provides dried herbs and fabrics for students to create scented herb sachets, experiencing the aroma therapeutic benefits.
24) The teacher instructs students on how to create herbal bath salts using aromatic herbs and natural salts. The students can customize their own blends.

### Activities for the Interpersonal Multiple Intelligence for Cycle 1.1.

Exemplary proposed activities are:
1) The teacher creates a large tree outline on a bulletin board or wall. The teacher provides students with leaf-shaped cutouts and encourage them to write positive messages or compliments for their classmates on the leaves. The teacher attaches the leaves to the tree, symbolizing a friendship tree.
2) The teacher hosts a potluck gathering where each student brings a plant-based dish to share, encouraging conversation about the benefits of different plant foods.
3) The teacher asks students to bring their favorite plant-based recipes to exchange with others, promoting discussion and exploration of new food ideas.
4) The teacher set up a smoothie bar with a variety of fruits, vegetables, and plant-based milk options. Students can create and taste different smoothie combinations.
5) The students collaborate on a community garden project, where students work together to grow and harvest their own fruits and vegetables, fostering teamwork and connection.
6) The teacher divides students into teams and provides them with a basket of plant-based ingredients. They must work together to create a delicious dish using only the provided ingredients.
7) The teacher teaches students different methods of food preservation, such as canning or freezing, to extend the shelf life of plant-based foods and reduce waste.
8) The teacher takes students on a guided tour of a grocery store, highlighting the plant-based options available and discussing the nutritional benefits of different foods.
9) The teacher arranges a circle where students bring plant-based dishes they have made and share the stories behind the recipes and the benefits of the ingredients used.
10) The teacher sets up a small kitchen garden where students can grow herbs, vegetables, or fruits together, fostering a sense of community and connection to nature.
11) The teacher hosts a cooking class that emphasizes cooking with seasonal plant-based ingredients, highlighting their freshness, flavor, and nutritional benefits.
12) The teacher conducts a workshop on reducing food waste, focusing on creative ways to use leftover plant-based ingredients and minimize environmental impact.
13) The teacher teaches students essential knife skills for preparing plant-based ingredients, emphasizing safety, efficiency, and proper techniques.
14) The teacher organizes a foraging expedition in a nearby natural area, educating students about edible wild plants and their benefits.
15) The teacher hosts an ice cream social featuring plant-based ice cream options, discussing the benefits of dairy-free alternatives and their delicious flavors.
16) The teacher organizes a panel discussion with experts in sustainable eating, exploring the environmental impact of plant-based diets and encouraging audience participation.
17) The teacher divides students into groups, gives each group a theme (home plants or wild plants) and lets them design a poster using pictures and instructions explaining the importance and their needs.

### Activities for the Intrapersonal Multiple Intelligence for Cycle 1.1.

Exemplary proposed activities are:
1) Each student sets a personal goal for improving their ability to meet the needs of seeds for water and warmth, and creates an action plan to achieve those goals.
2) Students create a personal mantra or affirmation related to the needs of seeds for water and warmth and repeat it daily to reinforce the importance of these factors in plant growth.
3) Students design a vision board that represents their aspirations for creating an optimal environment for seed growth, incorporating images, words, and symbols related to water and warmth.
4) The teacher engages students in mindful meditation and focus attention on the needs of seeds for water and warmth, cultivating a deep sense of connection with the natural world.
5) Each student sets aside dedicated time each day to connect with nature, whether through walks in a park, tending to plants, or simply observing the natural environment, and reflects on the needs of seeds for water and warmth during these moments.
6) Students write a letter to their future self, expressing their hopes and aspirations for their understanding and practice of meeting the needs of seeds for water and warmth, and set a date to read the letter in the future as a reminder of their commitment.
7) Students explore the concept of self-regulation by identifying strategies and techniques that help them maintain a balanced internal environment, just as seeds require the right balance of water and warmth.
8) The teacher engages each student in a personal photography project where they capture images that symbolize the needs of seeds for water and warmth and reflect on the symbolism and meaning behind each photograph.
9) Each student sets a personal mission statement that encapsulates his/her commitment to understand and meet the needs of seeds for water and warmth and use it as a guiding principle in his/her actions.
10) Students write a personal letter to a seed, expressing their appreciation for its role in the cycle of life and their commitment to meeting its needs for water and warmth.
11) The teacher takes a few minutes to make students think deeply about the role of soil in plant growth.
12) Students consider the nutrients, water retention, and anchorage it provides. Students reflect on why soil is important for plants to thrive.
13) Students read books, articles, or research papers on topics related to air and plant growth.
14) Students take notes and reflect on the main ideas and concepts encountered.

### Activities for the Musical Multiple Intelligence for Cycle 1.1.

Exemplary proposed activities are:
1) The teacher creates a seed-themed dance party where students dance to music representing the different stages of seed growth, incorporating movements like sprouting, growing, reaching for sunlight, and being nourished by water.
2) The teacher designs a musical meditation or relaxation session focusing on water and warmth themes, using soothing sounds and melodies to promote a sense of calm and connectedness for students.
3) The teacher writes a musical composition including sounds or samples of water and warmth, such as recorded raindrops or crackling fire, allowing students to listen and enhance their sensory experience and connection to seed growth.
4) The teacher engages students in a musical storytelling activity where they create a soundtrack or background music for a student's book or story emphasizing the needs of seeds for water and warmth.
5) The teacher hosts a musical contest or challenge where students compose or perform a piece of music effectively communicating the needs of seeds for water and warmth.
6) The teacher conducts a musical experiment comparing seed growth exposed to different types of music, exploring whether certain musical styles or genres positively impact seed growth.
7) The teacher composes a simple song about the importance of soil for plant growth, including lyrics explaining how soil provides nutrients, water, and support for plants. Teach the song to students to reinforce the concept.
8) The teacher creates a simple song with lyrics about the importance of air for plants and have students sing it together as a class.
9) The teacher explores different rhythmic patterns using percussion instruments or body percussion to represent the movement of air and its role in plant growth. Have students create their own rhythmic patterns and perform them in groups.
10) The teacher divides the class into small groups, assigning each group a specific instrument or sound-making object. The teacher instructs them to create sounds representing elements involved in plant growth, including air, then perform them together to create a plant symphony.
11) The teacher leads students in vocal warm-up exercises focusing on breath control and airflow. The teacher guides them to explore different vocal techniques, such as whispering, sighing, or imitating the sound of wind, connecting their voices with the concept of air.
12) The teacher teaches students a simple dance routine representing the movement of sunbeams. The teacher encourages them to use their bodies to mimic the path of light and express how it nourishes plants.

### Activities for the Naturalistic Multiple Intelligence for Cycle 1.1.

Exemplary proposed activities are:
1) Students plant seeds and observe their growth, ensuring they receive necessary water and warmth.
2) The teacher conducts a water experiment demonstrating water's importance for seed germination.
3) Students visit a local farm or botanical garden to learn seedling care techniques.
4) Students collect rainwater for watering seeds, utilizing natural water sources.
5) Students create a do-it-yourself (“DIY”) irrigation system to provide consistent water to seeds.
6) Students study different soil types and experiment with soil mixes for optimal growth.
7) Students visit a water treatment plant to understand water purification's importance.
8) Students design and construct a solar-powered water pump for sustainable watering.
9) Students take a trip to a desert to learn about plant adaptations to arid environments.
10) Students visit a seed bank or library to learn about seed preservation efforts.
11) Students start a composting project to create nutrient-rich soil for plants.
12) Students engage in worm observation to learn about their role in soil health.
13) Students explore plant roots'function in anchoring plants and absorbing water.
14) Students study soil microorganisms under a microscope and discuss their roles.
15) The teacher demonstrates plant respiration with a sealed container and condensation.
16) Students conduct a leaf bubble experiment to observe oxygen release from leaves.
17) The teacher allows students to work in small groups to design a garden space for the school. They can draw their ideas and discuss what plants would be suitable for the space, considering factors such as sunlight and soil conditions.
18) The teacher hosts a hands-on cooking workshop where students can learn to prepare delicious meals using plant-based ingredients, emphasizing their health benefits and culinary potential.

### Example 6. Plants (cycle 1.2 Germination of Seeds) Module

Another example of an application of the invention's camera/computer program system is as applied to the Plants (Cycle 1.2 Germination of Seeds) module is shown below. Recommended activities are provided for each multiple intelligence (spatial, kinesthetic, logical, linguistic, musical, naturalistic, interpersonal or intrapersonal).

### Activities for the Spatial Multiple Intelligence for Cycle 1.2

Exemplary proposed activities are:
1) Students sort a collection of seeds based on their color, shape, and size, creating groups of seeds with similar characteristics.
2) Students create a mosaic artwork using seeds of various colors and sizes, exploring their spatial arrangement to form patterns or images.
3) Students make a model of a seed using cardboard, clay or play dough, and then label each part with small flags or markers.
4) Students create a flipbook animation that illustrates the sequential steps of planting a seed and the subsequent growth of the plant.
5) Students design and decorate a seed packet, including illustrations and instructions for planting and caring for the specific type of seed.
6) Students construct a seed library or display case, where students organizing different types of seeds in labeled compartments for easy access and observation.
7) Students design and construct a seedling machine or apparatus that organizes different types of seeds based on their size, shape, or color.
8) The teacher sets up a seedling adoption center, inviting other students to “adopt” and care for seedlings at different stages of growth.

### Activities for the Linguistic Multiple Intelligence for Cycle 1.2

Exemplary proposed activities are:
1) Students write detailed descriptions of seeds, focusing on their colors, shapes, and sizes, and challenge others to identify the seeds based on their descriptions.
2) Students conduct research on different types of seeds, documenting their characteristics such as color, shape, size, and any unique features they possess.
3) The teacher prepares a word search puzzle using seed-related vocabulary words, such as colors, shapes, sizes, and different types of seeds. Students then search for seed-related vocabulary words.
4) The teacher tells a story that involves different types of seeds, describing their colors, shapes, and sizes as part of the narrative. The students listen and recall the story.
5) Students make a storyboard that tells a visual story about different types of seeds, illustrating their colors, shapes, sizes, and any transformations they undergo.
6) The teacher mixes up the letters of different seed part names and challenges students to unscramble them to form the correct labels.
7) Students write a set of instructions or a manual on how to plant a specific type of seed, including details such as ideal planting depth, watering frequency, and sunlight requirements.
8) Students perform a speech advocating for the inclusion of gardening and plant education in school curricula, highlighting the benefits for students'learning and well-being.
9) The teacher creates a podcast episode where students interview a plant expert about the process of growing plants from seeds.
10) The teacher organizes a plant sale or exchange event where students share the joy of growing plants from seeds with others.

### Activities for the Logical Multiple Intelligence for Cycle 1.2

Exemplary proposed activities are:
1) Students identify and analyze patterns in the color, shape, and size of different types of seeds, and create a pattern sequence based on the observations.
2) The teacher demonstrates a chart with different types of seeds listed in the rows and their color, shape, and size as columns, and allows the students to fill in the information for each seed.
3) Students use a ruler or caliper to measure the length, width, and height of different types of seeds, and compare the measurements to identify similarities and differences.
4) Show bar graphs or line graphs for the students and let them compare the color, shape, and size of different types of seeds.
5) Students estimate the number of seeds in a given sample based on their color, shape, and size, and compare the estimates to the actual count.
6) Students complete a logic grid puzzle by deducing the color, shape, and size of different types of seeds based on a set of given clues.
7) Students write or fill statements comparing the color, shape, and size of different types of seeds using logical connectors (e.g., “Seed A is larger than Seed B,” “Seed C and Seed D have the same color.
8) The teacher creates a decision tree to make students determine the appropriate actions to take at each stage of the planting process, based on different environmental factors.
9) The teacher has students write a computer program or code that simulates the growth of a plant from seed to maturity, incorporating logical rules and variables.
11) Students investigate the effects of different watering schedules on plant growth by watering plants at different intervals or using self-watering systems.

### Activities for the Kinesthetic Multiple Intelligence for Cycle 1.2

Exemplary proposed activities are:
1) The teacher creates colored circles on the ground representing different types of seeds, and has students physically toss corresponding seeds onto the circles based on their characteristics.
2) The teacher provides students with spoons and various types of seeds. They must balance the seeds on the spoon and carry them to a designated area, sorting them based on their characteristics.
3) The teacher inflates balloons and writes seed part labels on them. The teacher scatters the balloons around a designated area and asks students to pop the balloons and match the labels to the corresponding parts on a large diagram or model.
4) The teacher provides each participant with a labeled puzzle piece representing a seed part. They have to mingle, exchanging pieces with each other until they find the correct match for their labeled part.
5) The teacher sets up a “Garden Puppet Show” where students use puppets or their hands to act out the steps of planting a seed and the subsequent growth of a plant.

### Activities for the Interpersonal Multiple Intelligence for Cycle 1.2

Exemplary proposed activities are:
1) The teacher organizes a seed exchange event where students bring different types of seeds to share with each other. They can discuss the characteristics of the seeds they brought and trade them.
2) The teacher divides students into teams and provide each team with a large diagram or model of a seed without labels. Each team has to work together to label the different parts and discuss their functions.
3) The teacher poses a question or scenario related to seed parts and asks students to think individually, pair up with a partner to discuss their ideas, and then share their thoughts with the larger group.
4) The teacher provides each participant with a small poster board or chart paper and ask them to individually draw and label a seed part. Then, they can combine their individual posters to create a collaborative poster labeling all the parts together.
5) The teacher arranges students in a circle and facilitates a roundtable discussion where each person shares their understanding of a specific seed part, labeling it and explaining its role in the seed.
6) The teacher pairs students up and assigns each pair a different step of planting a seed. They must interview each other about their assigned step, asking questions to gather information and understanding.
6) The teacher organizes a “Teach and Learn” activity where participants pair up, and one person teaches the other about a specific step of planting a seed. They can use visual aids or props to enhance their explanation.

### Activities for the Intrapersonal Multiple Intelligence for Cycle 1.2

Exemplary proposed activities are:
1) Students practice gratitude by reflecting on the characteristics of different types of seeds and expressing appreciation for their beauty, diversity, and life-sustaining qualities.
2) Students develop positive affirmations related to the characteristics of seeds, such as “I appreciate the vibrant colors and diverse shapes of seeds,” and repeat them regularly for self-empowerment.
3) Students write a fictional autobiography from the perspective of a seed, exploring its growth, characteristics, and interactions with the environment.
4) Students design and create jewelry pieces that incorporate different types of seeds, wearing them as reminders of their characteristics and symbolic significance.
5) Students explore the aromas associated with different types of seeds, such as crushed herbs or spices, and reflect on how scent can enhance the understanding of their characteristics.
6) Students create a timeline or chronological record of personal encounters with different types of seeds, noting their characteristics and the insights gained over time.
7) Students use digital art tools or software to create digital illustrations or paintings of different types of seeds, emphasizing their characteristics and experimenting with different styles and effects.
8) Students research and study the different parts of a seed using books, online resources, or scientific journals. Students label a diagram or model of a seed based on their understanding.
7) Students set personal goals for improving understanding and skills in each step of planting a seed. Students create an action plan to achieve those goals.

### Activities for the Musical Multiple Intelligence for Cycle 1.2

Exemplary proposed activities are:
1) Students develop chants or repetitive vocal patterns that represent the colors, shapes, and sizes of different types of seeds, exploring different vocal techniques and harmonies.
2) The teacher combines physical movements and music for the students to express the characteristics of different types of seeds, using dance or body percussion to represent their color, shape, and size.
3) Students sort different types of seeds based on their characteristics, assigning each type a specific musical note or instrument. Students create a composition by arranging and playing the seeds in their designated order.
4) Students collect different types of seeds and place them in containers. Students shake each container and guess the seed based on the sound it makes, connecting auditory cues to the characteristics of the seeds.
8) The teacher incorporates natural sounds into music compositions or performances. The teacher experiments with field recordings or use instruments that mimic natural sounds.

### Activities for the Naturalistic Multiple Intelligence for Cycle 1.2

Exemplary proposed activities are:
1) Students dissect different types of seeds to explore their internal structures and identify unique characteristics.
2) Students plant different types of seeds in pots or in a garden, carefully noting their characteristics and observing their growth over time.
3) Students take photographs of different types of seeds in their natural settings, capturing their characteristics and showcasing their beauty through photography.
4) Students use different types of seeds to create leaf prints by pressing them onto paper or fabric, appreciating their characteristics and incorporating them into artistic creations.
5) Students use different types of seeds to create natural dyes, students exploring their color characteristics and applying the dyes to fabric or other materials.
6) The teacher allows students to save seeds from mature plants for future planting or sharing with others.
7) Students set up a seedling observation station, equipped with magnifying glasses, microscopes, and other tools where students examine seedlings up close.

### Example 7. Plants (Cycle 1.3 Components of a Garden) Module

Another example of an application of the invention's camera/computer program system is as applied to the Plants (Cycle 1.3 Components of a Garden) module is shown below. Recommended activities are provided for each multiple intelligence (spatial, kinesthetic, logical, linguistic, musical, naturalistic, interpersonal or intrapersonal).

### Activities for the Spatial Multiple Intelligence for Cycle 1.3

Exemplary proposed activities are:
1) The teacher provide students with a map of a garden and ask them to identify and label different areas or features such as flower beds, paths, trees, and seating areas.
2) The teacher asks students to create a design for their imaginary garden. The teacher provides them with a blank sheet of paper and art supplies, and encourage them to plan where they would place different elements, such as flowers, trees, and a seating area.
3) The teacher provides a list of items or features commonly found in a garden, such as a birdhouse, a watering can, or a flower pot. The teacher has the students search for these items in a real or virtual garden setting.
4) The teacher shows pictures of both types of gardens (private/public) and asks students to identify the distinguishing features of each one.
5) The teacher displays pictures of various gardens and asks students to determine whether each one is a public or private garden. They can discuss their reasoning and spatially categorize the images accordingly.
6) The teacher gives each student a drawing or a small model of a yard and a vegetable garden. The teacher has them imagine a new subject or things they love to have it in the garden. The teacher allows each student to label or draw what they imagine on the small model. The teacher collects all the papers and sticks them on a sticky board.
7) The teacher shows students a sample of a sign that motivates people to respect gardens. The teacher asks the students to make their special signs on a white paper (draw-color and label it). The teacher collects the signs in a poster.
8) The teacher provide students with materials such as clay, recycled materials, or building blocks. The teacher asks them to create a model of a garden, incorporating different spatial elements such as plants, pathways, and seating areas.
9) The teacher makes a virtual tour in some special gardens in the world.

### Activities for the Linguistic Multiple Intelligence for Cycle 1.3

Exemplary proposed activities are:
1) A Vocabulary Word Wall activity wherein the students create a word wall with garden-related vocabulary words, such as soil, seeds, plants, flowers, vegetables, orchard, yard, public, private, etc. The teacher has the students use the word wall to practice spelling, writing sentences, or playing vocabulary games.
2) A Garden Word Search activity wherein the students are provided a garden-themed word search puzzle. The puzzle can include words like garden, flower, seeds, and vegetables, public, private, etc. Students can find and circle the words, practicing their spelling and word recognition skills.
3) A Garden Descriptive Writing activity wherein the students are asked to write a descriptive paragraph or short story about a garden. The teacher encourages the students to use sensory language and vivid details to describe the sights, sounds, and smells of the garden.
4) A Sentence Formation activity wherein students are provided with sentence cards that describe different gardens. Some sentences should describe public gardens, while others describe private gardens. The teacher asks students to sort the sentences into two categories and practice reading them aloud.
5) A Types of Private Gardens activity wherein students are introduced to the three different types of private gardens: orchard, vegetable garden, and yard. The teacher has the students create sentences or short paragraphs describing each type of garden and their unique features.
6) An “In My Yard, In My Vegetable Garden” activity wherein students are provided sentence starters such as “In my yard, I have . . . ” or “In my vegetable garden, I grow . . . ” and ask the students to complete the sentences with their own ideas. They can share their sentences with the class, practicing sentence formation and vocabulary usage.
7) A Public Garden Etiquette activity wherein ways to respect and care for public gardens are discussed. The teacher asks students to generate a list of sentences or rules that explain how to behave in a public garden. They can write or illustrate these rules to create a classroom poster or booklet.
8) A Garden Story Starters activity wherein students are provided with sentence starters such as “Once upon a time, there was a magical garden . . . ” or “In the garden, I discovered a hidden treasure . . . ”. The teacher asks students to complete the sentences and continue the story, practicing their storytelling and creative writing skills.
9) A Garden Brochure activity wherein students create a brochure about gardens, highlighting different types of gardens, their uses, and features. They can include descriptions, illustrations, and captions, and practice persuasive writing to encourage people to visit or create their own gardens. 10) An “I Am a Garden”″ Monologue activity wherein each student is asked to imagine and pretend that they are a garden. The teacher provide the students with prompts or questions to guide their thinking. Some prompts may include:
What colors would dominate their garden?
How would they feel as a garden?
What sounds would be heard in their garden?
How would they describe their garden's atmosphere?
What animals or insects would visit their garden?
What do the garden need from the people?

### Activities for the Logical Multiple Intelligence for Cycle 1.3

Exemplary proposed activities are:
1) A Garden Sorting activity wherein students prepare a set of picture cards depicting different elements found in gardens, such as plants, tools, animals, and structures. The teacher asks students to sort the cards into categories based on their characteristics or functions.
2) A Garden Classification activity wherein students are provided with a list of different types of gardens, including public gardens or private (orchards, vegetable gardens, and yards). The teacher asks the students to classify each garden type into the appropriate category and explain their reasoning.
3) A Garden Uses Match-Up activity wherein students create a set of cards with descriptions or pictures of various garden uses, such as relaxation, growing food, attracting wildlife, and providing beauty. The teacher has students match each use with the corresponding type of garden where it is commonly found.
4) A Garden Venn Diagram activity wherein students draw a Venn diagram on the board or provide a printed template with two overlapping circles. The teacher labels one circle “Private Gardens” and the other circle “Public Gardens.” The teacher asks students to list characteristics or features of each type of garden in the appropriate section and identify shared traits in the overlapping area.
5) A Garden Comparison Chart activity wherein students are provided with a chart comparing private and public gardens. The teacher includes categories such as ownership, access, purpose, and maintenance. The teacher asks students to complete the chart by filling in the relevant information for each type of garden.
6) A Respect a Public Garden Puzzle activity wherein the teacher creates a puzzle with different actions or behaviors related to respecting a public garden, such as staying on the paths, not picking flowers, and disposing of trash properly. The teacher asks students to solve the puzzle by matching each action with its corresponding way to respect a public garden.
7) A Garden Maintenance Sequence activity wherein the teacher provides students with a set of cards depicting different tasks involved in maintaining a garden, such as watering plants, weeding, and pruning. The teacher asks them to arrange the cards in the correct sequence that represents the logical order of performing these tasks.
8) A Garden Cause and Effect activity wherein the teacher discuss cause-and-effect relationships in a garden context. The teacher provides examples such as “If a garden is not watered, the plants will wilt” or “If insects are attracted to a garden, it means the flowers are blooming.” The teacher ask students to identify the cause and effect in each scenario and explain the logic behind it.

### Activities for the Kinesthetic Multiple Intelligence for Cycle 1.3

Exemplary proposed activities are:
1) A Garden Walk and Talk activity wherein the students are taken on a guided walk around a garden or outdoor space. As they walk, the teacher encourages them to observe and interact with the different elements they see, such as plants, flowers, trees, and insects. The teacher engages them in a conversation about what they notice and their thoughts about gardens.
2) A Garden Role Play activity wherein the teacher sets up a garden-themed role play area in the classroom or outdoor space. Provide props such as gardening tools, plants, and watering cans. Assign students different roles, such as gardeners, plants, insects, or visitors, and encourage them to act out different scenarios related to gardens and their uses.
3) A Garden Relay Race activity wherein the teacher divides the students into teams and sets up a relay race course. The teacher places various garden-related objects or flashcards at different stations. Each student, in turn, has to run to a station, pick up an object or flashcard, and then run back to their team to explain or demonstrate what it represents in a garden.
4) A Garden Mime activity wherein the teacher assign each student a garden-related word or concept, such as watering can, seeds, pollination, or sunlight. Students take turns acting out their assigned word or concept while the rest of the class tries to guess what it is. This activity helps reinforce vocabulary and understanding of garden-related concepts.
5) A Garden Alphabet activity wherein the teacher creates large flashcards with letters of the alphabet. The teacher scatters them around the garden or outdoor space. The teacher instructs students to move around and find the flashcards. When they find a flashcard, they have to think of a garden-related word or elements inside the garden that starts with that letter and share it with the class.
6) A Garden Planting Activity wherein the teacher provide small pots, soil, and seeds to each student. The teacher guides them in planting the seeds and taking care of their own small plants. This hands-on activity allows students to experience the process of planting and nurturing plants in a garden.
7) A Breathing Exercise activity wherein the teacher guides the students through a breathing exercise where they take deep breaths, mimicking the way plants take in carbon dioxide and release oxygen. The teacher emphasizes the importance of clean air for plants and humans.
9) A Leaf Aerobics activity wherein the teacher instructs students to imagine they are leaves on a plant and demonstrate different leaf movements. The teacher has them stretch their arms out like leaves, sway gently, or flutter their hands to imitate the movement of leaves in the wind.

### Activities for the Interpersonal Multiple Intelligence for Cycle 1.3

Exemplary proposed activities are:
1) A Garden Sharing Circle activity wherein the teacher sits in a circle with the students and has a discussion about gardens. The teacher gives each student a chance to share their thoughts, experiences, or stories related to gardens. The teacher encourages active listening and respectful responses from their peers.
2) A Garden Interview activity wherein the teacher pairs up the students and have them interview each other about gardens. The teacher provides a list of questions or prompts, such as “What is your favorite thing about gardens?” or “Have you ever visited a public garden? What was it like?” After the interviews, The teacher invites students to share interesting things they learned about their partners'experiences.
3) A Garden Collaborative Art activity wherein the teacher divides the students into small groups and provide a large piece of paper or a poster board for each group. The teacher instructs them to create a collaborative garden-themed artwork by drawing, coloring, and adding elements of a garden. The teacher encourages them to discuss and decide on the different features they want to include in their artwork.
4) Garden Role Play activity wherein the teacher assigns different roles to students, such as gardeners, visitors, plants, or animals. The teacher encourages them to interact and communicate with each other, pretending to be in a garden setting. This activity allows students to practice interpersonal skills, negotiation, and cooperation.
5) A Garden Show and Tell activity wherein the teacher asks each student to bring in a small object, photograph, or drawing related to gardens. The teacher provides time for each student to present his/her item to the class, explaining its connection to gardens and why it is meaningful to them. The teacher encourages students to ask questions and show interest in their classmates'presentations.
6) A Garden Storytelling Circle activity wherein the teacher creates a storytelling activity where students sit in a circle and take turns adding a sentence or a short segment to create a collaborative garden story. Each student builds upon the previous contribution, creating a unique and imaginative story about gardens.
7) A Garden Reflection Journals activity wherein the teacher provide each student with a garden-themed journal or notebook. The teacher assigns regular reflection periods where students can write or draw their thoughts, feelings, or experiences related to gardens. The teacher encourages the students to share their journal entries with a partner or in a small group to foster interpersonal communication.
8) A Garden Design Group Project activity wherein the teacher divides the students into small groups and assigns them the task of designing their ideal garden. Each group can collaborate to draw a plan, discuss features, and explain their design choices to the class. This activity promotes teamwork, communication, and the exploration of different perspectives.
9) A Garden Photography Exhibition activity wherein students bring in photographs or images of gardens they have visited or their own gardens at home. The teacher organizes a classroom exhibition where students display their photographs and share their experiences with their peers. Students are encouraged to ask questions and provide positive feedback to their classmates.
10) A Garden Appreciation Cards activity wherein art supplies are provided such as colored paper, markers, and stickers. The teacher instructs students to create appreciation cards for a public garden in their community. The students can design the cards with drawings, messages, or expressions of gratitude. The teacher encourages students to reflect on the importance of public gardens and the value they bring to the community.
10) A Code of Conduct activity wherein students gather in groups and create a code of conduct or a set of guidelines for visitors to a public garden. They can use words and visual symbols to represent the rules and emphasize spatial organization.

### Activities for the Intrapersonal Multiple Intelligence for Cycle 1.3

Exemplary proposed activities are:
1) A Garden Journaling activity wherein the teacher provides each student with a garden-themed journal or notebook. The teacher encourages the students to write or draw about their personal thoughts, feelings, and experiences related to gardens. They can reflect on their favorite aspects of gardens, their own gardening experiences, or their observations of nature.
2) A Garden Reflection Worksheet activity wherein the teacher creates a worksheet with prompts related to gardens, such as “What do you think a garden needs to grow?” or “How would you use a garden if you had one?” The teacher has the students complete the worksheet individually and reflect on their own thoughts and ideas.
3) A Garden Visualization and Guided Imagery activity wherein the teacher leads the students through a guided visualization activity where they imagine themselves in a beautiful garden. The teacher encourages the students to use their senses to imagine the sights, sounds, smells, and textures of the garden. After the visualization, the teacher provides time for personal reflection and expression through drawing or writing about their imagined garden experience.
4) A Garden Goal Setting activity wherein the teacher asks students to set personal goals related to gardens and write them down. It could be a goal to plant and care for a small plant, visit a public garden, or learn about different types of plants. The teacher encourage the students to reflect on why these goals are important to them and how they plan to achieve them.
5) A Garden Mindfulness activity wherein the teacher guides the students through a mindfulness activity focused on gardens. The teacher has the students sit quietly, close their eyes, and bring their attention to their breath. Then, the teacher instructs them to imagine being in a peaceful garden, focusing on the sensations and sounds they would experience. Afterward, the teacher provides time for personal reflection and for sharing any insights or feelings that arose during the activity.
6) A Garden Art Expression activity wherein the teacher provide arts supplies such as colored pencils, markers, or watercolors. The teacher encourages students to create a garden-themed artwork that represents their personal connection to gardens. They can draw or paint elements of a garden that hold significance for them or express their feelings through their artwork.
7) A Garden Personal Collage activity where the teacher asks students to bring in magazines or printed images related to gardens. The teacher provide the students with large sheets of paper or poster boards and have them create a personal collage using the images that resonate with them. After completing their collages, the teacher give the students time to reflect on the choices they made and share their collages with the class.

11) A Garden Storytelling activity wherein the teacher invites students to create and tell their own stories about gardens. They can write or orally share stories about imaginary gardens, real-life garden experiences, or the adventures of characters in a garden setting. The teacher encourage the students to explore their creativity and imagination while reflecting on their personal connections to gardens.

### Activities for the Musical Multiple Intelligence for Cycle 1.3

Exemplary proposed activities are:
1) A Garden Song activity wherein the teacher teaches the students a garden-themed song or create one together as a class. The song can include lyrics about the beauty of gardens, the different types of plants, or the importance of taking care of nature. The teacher adds simple hand movements or actions to make it interactive and engaging.
2) A Soundscapes of a Garden activity wherein the teacher divides the students into small groups and assign each group a specific aspect of a garden (e.g., birds, insects, wind, or water). The teacher provides the students with various musical instruments or objects that can produce sound. The teacher instructs the groups to create soundscapes that represent their assigned garden element. The teacher has the groups perform their soundscapes simultaneously to create a collaborative garden soundscape.
3) A Garden Dance activity where the teacher selects a lively piece of music and create a garden-themed dance routine together. The teacher incorporate movements and gestures that represent different aspects of a garden, such as planting seeds, blooming flowers, or fluttering butterflies. The students practice the dance as a group and perform it for the class or during a school event.
4) A Musical Garden Story activity wherein the teacher chooses a garden-related story or create one specifically for this activity. The teacher divides the story into sections and assign each section to a group of students. The teacher instructs the groups to create a short musical piece that represents their assigned section of the story. The teacher has the students use instruments, body percussion, or their voices to bring the story to life through music.
5) A Garden Instrument Exploration wherein the teacher sets up a variety of musical instruments in the classroom, such as drums, shakers, xylophones, and recorders. The teacher allows the students to explore and experiment with the instruments, creating their own garden-inspired melodies or rhythms. The teacher encourages the students to listen to each other and collaborate in creating a musical garden atmosphere.
6) A Garden Rhythms activity wherein the students are taught different rhythmic patterns using body percussion or handheld percussion instruments. The teacher assigns each student or small group a garden-related word or phrase (e.g., “sunflower,” “watering can,” “butterfly”). The teacher instruct the students to create a rhythmic pattern using the syllables of their assigned word or phrase. The class or the teacher combines the patterns to create a rhythmic garden composition.
7) A Garden Instrument Sorting activity wherein the teacher prepares a collection of pictures or flashcards representing various musical instruments. The teacher divides the class into groups and provide each group with a set of instrument pictures. The teacher then instructs the students to sort the instruments into categories based on whether they think they would be found in a private garden or a public garden. The teacher encourages discussion and explanation of their choices.
8) A Garden Music Listening activity wherein the teacher plays different pieces of music that evoke the feeling of being in a garden. The teacher asks the students to listen attentively and then share their thoughts and feelings about the music. The teacher encourages them to describe the sounds they hear and how it makes them imagine being in a garden.
9) A Garden Musical Storytelling activity wherein the teacher provides a garden-related story or poem with a clear narrative structure. The teacher instructs the students to create a musical accompaniment to the story by using their voices, percussion instruments, or body percussion. As the story unfolds, the students can create sound effects, rhythmic patterns, or melodies that enhance the emotions and events in the story.
12) A Garden Musical Reflection activity wherein the teacher discusses ways to respect a public garden. The students then reflect on their personal experiences in a public garden through music. The students are provided with musical instruments, drawing materials, or a digital music creation tool. The teacher asks them to express their feelings and experiences in the public garden by creating a musical composition, a graphic representation, or a combination of both.

### Activities for the Naturalistic Multiple Intelligence for Cycle 1.3

Exemplary proposed activities are:
1) A Garden Scavenger Hunt activity wherein the teacher takes the students on a garden scavenger hunt where they search for specific natural elements within a garden, such as different types of flowers, insects, or leaves. The teacher provides the students with a checklist or pictures to identify and mark off the items they find. The teacher encourages the students to observe and appreciate the natural beauty of the garden.
2) A Nature Walk in a Garden activity wherein the teacher arranges a nature walk in a local garden or natural space. The teacher guides the students to observe and interact with the plants, trees, and wildlife they encounter. The teacher encourages the students to ask questions, make observations, and describe their experiences during the walk. Afterward, the teacher facilitates a discussion about the different aspects of the garden they explored.
3) A Garden Exploration and Observation activity wherein the teacher provides magnifying glasses, notebooks, and pencils to the students. The teacher instructs the students to choose a specific area within a garden and spend time observing the plants, insects, or other natural elements they find. The teacher encourages the students to record their observations, draw pictures, or write descriptive sentences about what they see. Afterwards, the students share their findings with the class.
4) A Plant Identification Game activity wherein the teacher creates a game where students match pictures or descriptions of plants commonly found in gardens with their names. The teacher provides flashcards with plant images or descriptions, and has the students work individually or in pairs to match them with the correct plant names. This activity helps students become familiar with different types of plants and their characteristics.
5) A Garden Design and Planning activity wherein the teacher gives each student a piece of paper and colored pencils or markers. The teacher ask the students to design their own garden by drawing and labeling different elements, such as flowers, trees, paths, and a seating area. The teacher encourages them to think about the purpose of their garden and how they want it to look. Afterward, the students share their garden designs with their peers.
6) A Planting and Caring for Seeds activity wherein the teacher provides each student with a small pot, soil, and seeds. The teacher guides the students through the process of planting the seeds and caring for them. The teacher teaches the students how to water the plants and monitor their growth. The teacher encourages them to record the changes they observe over time and share their experiences with the class.
7) A Garden Storytelling activity wherein the teacher invites the students to create and share their own stories about gardens. The teacher encourages the students to include elements of nature, such as plants, animals, or insects, in their stories. The students can write or orally share their stories, allowing their imagination to bring gardens to life through storytelling.
8) A Nature Art activity wherein the teacher takes the students outside to gather natural materials from a garden, such as leaves, flowers, or small branches. The teacher provides the students with glue, paper, and other art supplies. The teacher instructs the students to create nature-inspired artwork using the materials they collected. This activity allows students to express their creativity while connecting with the natural elements of a garden.
9) A Garden Photography activity wherein the teacher provides digital cameras or smartphones to the students and take them to a garden or outdoor space. The teacher instruct the students to capture photographs of interesting plants, flowers, or natural features they find. Afterward, the teacher has the students share their photographs with the class and discuss what they found appealing or unique about the subjects they chose to photograph.
10) A Garden Nature Journal activity wherein the teacher assigns each student a garden-themed nature journal. The teacher encourages the students to regularly record their observations, thoughts, and experiences related to gardens. They can write about their visits to gardens, draw pictures of plants or animals they encounter, or reflect on the beauty of nature. The teacher provides time for students to share and discuss their journal entries with their peers.
11) A Garden Habitat Study activity wherein the teacher divides the students into small groups and assigns each group a specific habitat within a garden, such as a flower bed, a pond, or a tree. The teacher instructs the students to research and learn about the plants and animals that inhabit their assigned habitat. The teacher has the students create posters or presentations to share their findings and discuss the interdependence of living organisms within the garden ecosystem.
12) A Garden Poetry activity wherein the teacher introduces the students to garden-themed poetry or nursery rhymes. The teacher and the students discuss the descriptive language and imagery used in the poems. Then, the teacher guides the students in creating their own

garden poems. The teacher encourages the students to use descriptive words and sensory details to capture the essence of a garden in their writing.
13) A Garden Senses Walk activity wherein the teacher takes the students on a guided sensory walk in a garden. The teacher encourage the students to use their senses to explore and describe what they see, hear, smell, touch, and even taste (if it's safe). The teacher provides them with journals or worksheets where they can record their sensory observations. In a follow-up discussion, the teacher ask the students to share their favorite sensory experiences from the walk.
14) A Garden Food Tasting activity wherein the teacher introduces the concept of edible plants that are commonly found in gardens, such as fruits, vegetables, or herbs. Arrange a tasting session where students can sample different garden-fresh foods. Discuss the importance of healthy eating and how gardens can provide fresh and nutritious food. Encourage them to share their preferences and describe the flavors they experience.
15) A Garden Weather Observation activity wherein the teacher sets up a weather observation station in or near a garden. The teacher provides thermometers, rain gauges, and

wind socks or flags. The teacher instructs the students to regularly observe and record the weather conditions in the garden. The teacher and the students discuss how weather influences the growth and health of plants and the behavior of animals in the garden.
16) A Garden Story Mapping activity wherein the teacher chooses a garden-themed storybook and read it aloud to the class. Afterward, the teacher distributes large sheets of paper or use a whiteboard to create a story map. The teacher guides the students in identifying the main characters, settings, and events from the story. The teacher encourages the students to draw pictures or write keywords to represent different story elements on the map.
17) A Garden Insect Exploration activity wherein the teacher introduces the students to the world of insects commonly found in gardens. The teacher provides magnifying glasses and insect field guides. The teacher takes the students on an insect hunt in a garden or assign them to observe insects individually. The teacher as the students document their findings and create simple reports or presentations about the insects they encountered.
18) A Garden Animal Adaptations activity wherein the teacher discuss the different animals that can be found in gardens and their unique adaptations. The teacher assigns each student or small group an animal to research. The teacher instructs the students to create a visual or oral presentation describing the animal's physical features, behaviors, and how these adaptations help them survive in a garden environment.
19) A Garden Math activity wherein the teacher uses a garden as a context for math activities. For example, the teacher has students measure and record the height of different plants, count the number of petals on flowers, or estimate and measure the area of specific garden sections. The teacher encourages the students to use math vocabulary and explain their reasoning as they complete the activities.
8) A Garden Environmental Stewardship activity wherein the teacher engages the students in discussions and activities focused on being responsible stewards of the environment. The class brainstorms ways to reduce waste, conserve water, and promote biodiversity in gardens. The teacher assigns small projects such as creating compost bins, designing bird feeders, or planting native plants to attract pollinators.

### Example 8. Plants (cycle 1.4 Taking Care of a Garden) Module

Another example of an application of the invention's camera/computer program system is as applied to the Plants (Cycle 1.4 Taking Care of a Garden) module is shown below. Recommended activities are provided for each multiple intelligence (spatial, kinesthetic, logical, linguistic, musical, naturalistic, interpersonal or intrapersonal).

### Activities for the Spatial Multiple Intelligence for Cycle 1.4

Exemplary proposed activities are:
1) Students create a memory game using cards with pictures of gardening tools. Students should match the tools by flipping the cards and finding the corresponding pairs.
2) Students create jigsaw puzzles using pictures of gardening tools. Students can assemble the puzzles and discuss the tools as they put the pieces together.
3) Students design a maze on paper or using a digital tool, incorporating different gardening tools throughout the maze. Students should navigate through the maze, identifying and collecting the tools they encounter.
4) The teachers provides clay, play-dough, or other modeling materials. Students should sculpt different gardening tools, paying attention to their shapes and details.

### Activities for the Linguistic Multiple Intelligence for Cycle 1.4

Exemplary proposed activities are:
1) A Garden Tool Word Search activity wherein the teacher creates a word search puzzle with the names of different gardening tools. Have students find and circle the words in the puzzle, then write sentences using the words they found.
2) A Garden Tool Acrostic Poem activity wherein the teacher chooses a gardening tool and write an acrostic poem using the letters of the tool's name. Each line of the poem should start with a letter from the tool's name and describe its use or characteristics.
3) Garden Tool Story Starters activity wherein the teacher provided students with sentence starters related to gardening tools, such as “When I picked up the shovel, I felt . . . ” or “The rake helped me . . . ” Students complete the sentences and continue the story about their experiences with the tool.
4) Garden Tool Alphabet activity wherein the teacher challenges the students to create an alphabet chart where each letter represents a gardening tool. For each letter, they should write the tool's name, draw a picture of it, and write a sentence describing its purpose.
5) A Garden Tool Descriptions activity wherein the teacher displays pictures of gardening tools around the classroom. Provide students with descriptive words and adjectives to write detailed descriptions of each tool, emphasizing their features, materials, and functions.
6) A Garden Tool Scramble activity wherein the teacher rearranges the letters of different gardening tools and challenge students to unscramble them to identify the correct tool. Then, ask them to write sentences using the unscrambled words.
7) A Garden Tool Vocabulary Story activity wherein the teacher has students write a short story or paragraph using as many gardening tool vocabulary words as possible. Encourage them to incorporate the tools in creative and meaningful ways within their narratives.
8) A Garden Tool Research Report activity wherein the teacher assigns each student a different gardening tool to research. They should gather information about its history, uses, and benefits. Then, the students write a research report to share their findings with the class.
9) A Garden Tool Interview activity wherein the teacher pairs students up and assign each pair a gardening tool. Have them role-play an interview scenario where one student acts as the interviewer and the other as the gardening tool. They should ask and answer questions about the tool's purpose, usage, and importance in garden care.
10) A Garden Tool Rhyme Time activity wherein the teacher challenge students to create rhyming couplets or short poems using gardening tool vocabulary. Encourage them to use their imagination to come up with fun and rhyming lines while incorporating the tool names.
11) A Garden Tool Fact Cards activity wherein the teacher provides students with index cards and ask them to choose a gardening tool to research. They should write the tool's name, draw a picture of it, and write three interesting facts about its use or history on the card.
12) A Garden Tool Trading Cards activity wherein the teacher asks students to design trading cards featuring different gardening tools. They should include the tool's name, an illustration, and write a brief description of its purpose and how it is used in garden care.
13) A Garden Tool Advertisement activity wherein the teacher has students create persuasive advertisements for gardening tools. They should write slogans, design eye-catching visuals, and write persuasive paragraphs highlighting the benefits and features of the tools.
14) A Garden Tool Comic Strip activity wherein the teacher instructs students to create a comic strip featuring a story or scenario where gardening tools play a central role. They should incorporate dialogue bubbles and captions to depict the actions and interactions of the characters and tools.
15) A Garden Tool Opinion Writing activity wherein the teacher provides students with a prompt such as “Which is the most important gardening tool?” or “Which gardening tool would you choose for a specific task?” They should write an opinion piece expressing their thoughts and reasons, supporting their arguments with examples and evidence.

### Activities for the Logical Multiple Intelligence for Cycle 1.4

Exemplary proposed activities are:
1) A Garden Planning activity wherein the teacher has students design a garden layout, considering factors like plant spacing, sun exposure, and water needs to create an efficient and thriving garden.
2) A Measurement and Proportions activity wherein the teacher asks students to measure the garden space, calculate the area, and determine the appropriate number of plants and seeds to be planted.
3) A Soil Analysis activity wherein the teacher conducts a simple soil test to determine the pH level and nutrient composition, then have students research the optimal soil conditions for different plants.
4) A Watering Schedule activity wherein the teacher develops a watering schedule for the garden, taking into account factors like plant type, weather conditions, and water conservation.
5) A Pest Management activity wherein the teacher presents students with common garden pests and have them research effective, logical solutions to control or prevent infestations.
6) A Composting and Recycling activity wherein the teacher teaches students about the benefits of composting and have them track the volume and decomposition rate of organic matter.
7) A Seed Germination activity wherein the teacher sets up a seed germination experiment, allowing students to observe and record the growth rates and conditions that affect plant development.
8) A Garden Monitoring activity wherein the teacher has students regularly observe and record data on the garden's growth, such as plant height, leaf size, and flower/fruit production.
9) A Yield Calculations activity wherein the teacher asks students to estimate and calculate the expected yield of the garden, based on factors like plant spacing, maturity rates, and environmental conditions.
10) A Garden Expansion activity wherein the teacher challenges students to design a plan for expanding the garden, considering factors like available space, budget, and resource requirements.

### Activities for the Kinesthetic Multiple Intelligence for Cycle 1.4

Exemplary proposed activities are:
1) A Soil Preparation activity wherein the teacher engages students in the physical process of tilling, turning, and amending the garden soil using tools like shovels, rakes, and hoes.
2) A Planting Seeds and Seedlings activity wherein the teacher guides students through the hands-on process of planting seeds, transplanting seedlings, and ensuring proper depth and spacing.
3) A Watering the Garden activity wherein the teacher has students water the plants using watering cans or hoses, allowing them to develop a physical feel for the appropriate amount of water needed.
4) A Weeding and Cultivation activity wherein the teacher encourages students to get their hands dirty by manually removing weeds from the garden beds, strengthening their dexterity and hand-eye coordination.
5) A Pruning and Trimming activity wherein the teacher teaches students how to properly use pruning shears, scissors, or gardening snips to trim and shape plants, improving their fine motor skills.
6) A Mulching and Composting activity wherein the teacher involves students in the physical tasks of spreading mulch or compost around the garden, strengthening their overall body awareness and coordination.
7) A Garden Maintenance activity wherein the teacher asks students to perform physical tasks like sweeping paths, removing debris, or maintaining garden tools, enhancing their tactile and kinesthetic experiences.
8) A Sensory Exploration activity wherein the teacher encourages students to engage their senses by touching, smelling, and feeling different plants, soil textures, and garden materials.
9) A Garden Yoga or Stretches activity wherein the teacher incorporates gentle yoga or stretching exercises that relate to gardening movements, helping students develop body awareness and flexibility.
11) A Garden Art Projects activity wherein the teacher encourages students to create garden-themed art projects, such as handprint stepping stones or nature-inspired sculptures, using their hands and bodies.

### Activities for the Interpersonal Multiple Intelligence for Cycle 1.4

Exemplary proposed activities are:
1) A Garden Teamwork activity wherein the teacher divide students into small groups and assign them specific gardening tasks, such as planting, weeding, or watering, requiring them to collaborate and coordinate their efforts.
2) A Garden Planning activity wherein the teacher has students work together to design and plan the layout of the garden, negotiating decisions and compromising on design elements.
3) A Garden Journal activity wherein the teacher encourages students to keep a shared garden journal, where the students can record observations, share ideas, and provide feedback to one another.
4) A Garden Presentations activity wherein the teacher asks student groups to research a gardening topic and present their findings to the class, fostering communication and public speaking skills.
5) A Garden Buddy System activity wherein the teacher pairs up students to be responsible for monitoring and caring for a specific plant or section of the garden, promoting a sense of shared responsibility.
6) A Garden Mentor Program activity wherein the teacher asks older students to serve as mentors to younger students, sharing their gardening knowledge and providing guidance and support.
7) A Garden Community activity wherein the teacher organizes a school or neighborhood garden work day, allowing students to interact with parents, teachers, and community members while contributing to the garden's upkeep.
8) A Garden Problem-Solving activity wherein the teacher presents students with gardening challenges or issues and has them work together to develop and discuss potential solutions.
9) A Garden Sharing activity wherein the teacher encourages students to share their gardening experiences, successes, and challenges with their peers, fostering empathy and understanding.
12) A Garden Celebration activity wherein the teacher plans a garden-themed celebration or showcase, where students can display their work, share their knowledge, and engage with the community.

### Activities for the Intrapersonal Multiple Intelligence for Cycle 1.4

Exemplary proposed activities are:
1) A Garden Journaling activity wherein the teacher encourages students to keep a personal garden journal, where they can reflect on their experiences, emotions, and personal growth related to gardening.
2) A Garden Goal Setting activity wherein the teacher has students set individual goals for their gardening tasks, such as learning a new skill or achieving a specific outcome, and regularly review their progress.
3) Garden Mindfulness activity wherein the teacher: Incorporate mindfulness practices, such as guided meditations or sensory awareness exercises, to help students connect with the garden and their inner experiences.
4) A Garden Self-Evaluation activity wherein the teacher provides opportunities for students to assess their own gardening performance, identifying areas of strength and opportunities for improvement.
5) A Garden Visualization activity wherein the teacher asks students to visualize their ideal garden or imagine themselves successfully completing a gardening task, tapping into their inner mental processes.
6) A Garden Passion Project activity wherein the teacher encourages students to explore a specific gardening topic that aligns with their personal interests or strengths.
7) A Garden Emotional Exploration activity wherein the teacher has students reflect on the emotions they experience while gardening, such as joy, frustration, or pride, and how these emotions impact their learning.
8) A Garden Problem-Solving Strategies activity wherein the teacher guides students in developing their own problem-solving strategies for addressing gardening challenges, building self-awareness and self-regulation.
9) A Garden Resilience activity wherein the teacher supports students in learning from their mistakes or setbacks in the garden, fostering a growth mindset and developing their capacity for self-reflection.
10) A Garden Sharing and Feedback activity wherein the teacher provides opportunities for students to share their personal gardening experiences and receive constructive feedback, promoting self-awareness and self-improvement.

### Activities for the Musical Multiple Intelligence for Cycle 1.4

Exemplary proposed activities are:
1) A Composing Personal Songs activity wherein the teacher encourages students to create original musical compositions that reflect their personal experiences, emotions, or perspectives.
2) A Musical Journal activity wherein the teacher has students keep a journal where they can reflect on their musical learning, emotions, and personal growth.
3) A Musical Goal Setting activity wherein the teacher assists students in setting and tracks their individual musical goals, such as learning a new instrument or improving a specific technique.
4) A Musical Visualization activity wherein the teacher guides students in visualizing themselves successfully performing or creating music, tapping into their inner mental processes.
5) A Musical Passion Projects activity wherein the teacher provides opportunities for students to explore and pursue musical genres or instruments that align with their personal interests and strengths.
6) Musical Emotional Exploration activity wherein the teacher encourages students to reflect on the emotions they experience while engaging in musical activities and how those emotions impact their learning.
7) A Musical Problem-Solving Strategies activity wherein the teacher supports students in developing their own problem-solving strategies for addressing musical challenges, fostering self-awareness and self-regulation.
8) A Musical Resilience activity wherein the teacher helps students learn from their mistakes or setbacks in music, promoting a growth mindset and developing their capacity for self-reflection.
9) A Musical Mindfulness activity wherein the teacher incorporates mindfulness practices, such as deep listening or musical meditation, to help students connect with their inner experiences and the music they create.
11) A Musical Sharing and Feedback activity wherein the teacher provides opportunities for students to share their original musical compositions or performances and receive constructive feedback, promoting self-awareness and self-improvement.

### Activities for the Naturalistic Multiple Intelligence for Cycle 1.4

Exemplary proposed activities are:
1) A Nature Observation Journals activity wherein the teacher encourages students to keep detailed observation journals, and records their findings and insights about the natural world around them.
2) A Biodiversity Inventories activity wherein the teacher has students conduct surveys of the plant and animal life in the garden or local ecosystem, fostering their curiosity and appreciation for the natural environment.
3) An Environmental Problem-Solving activity wherein the teacher presents students with environmental challenges, such as invasive species or habitat destruction, and guides them in developing sustainable solutions.
4) A Nature-Inspired Art and Design activity wherein the teacher encourage students to create art projects, designs, or models inspired by the natural elements and patterns found in the garden or local environment.
5) An Outdoor Exploration Experiences activity wherein the teacher takes students on field trips or outdoor excursions to observe and interact with nature in different settings, such as forests, wetlands, or urban green spaces.
6) A Garden Phenology Tracking activity wherein the teacher has students monitor and record the seasonal changes and life cycles of plants and animals in the garden, developing their understanding of natural rhythms and processes.
7) A Citizen Science Projects activity wherein the teacher involves students in real-world scientific research by participating in community-based citizen science programs, contributing their observations and data to larger environmental studies.
8) A Sustainable Gardening Practices activity wherein the teacher teaches students about sustainable gardening techniques, such as composting, water conservation, and organic pest management, and has them implement these practices in the school garden.
9) A Nature Immersion Activities activity wherein the teacher incorporate activities that allow students to deeply connect with nature, such as forest bathing, nature meditation, or sensory awareness exercises.
9) An Environmental Stewardship Projects activity wherein the teacher encourages students to take action and become stewards of the local environment, such as organizing beach cleanups, planting native species, or advocating for conservation efforts.

### Example 9. Plants (cycle 1.5 Seasonal Plants and Green House Effect) Module

Another example of an application of the invention's camera/computer program system is as applied to the Plants (Cycle 1.5 Seasonal Plants and Green House Effect) module is shown below. Recommended activities are provided for each multiple intelligence (spatial, kinesthetic, logical, linguistic, musical, naturalistic, interpersonal or intrapersonal).

### Activities for the Spatial Multiple Intelligence for Cycle 1.5

Exemplary proposed activities are:
1) The teacher distributes a card displaying a plant and asks students to match the plant to the appropriate season.
2) Students build a diorama showcasing a seasonal plant's natural habitat, complete with miniature models or drawings.
3) Students illustrate a picture book about the life cycle of a specific seasonal plant, using detailed drawings and text.
4) Students construct a model of a greenhouse using recycled materials (e.g., boxes, plastic bottles, cardboard), and explain how the greenhouse helps plants grow.
5) Students design a floor plan or blueprint for an ideal greenhouse, considering the placement of plants, lighting, and other necessary features.

### Activities for the Linguistic Multiple Intelligence for Cycle 1.5

Exemplary proposed activities are:
1) Students describe the life cycle of a seasonal plant in a short story or picture book.
2) Students label the parts of a plant (roots, stems, leaves, flowers) and write a sentence about the function of each part.
3) Students create a class dictionary of seasonal plant vocabulary words, including their definitions and illustrations.
4) Students write a letter to a farmer or gardener, asking questions about how they care for their seasonal plants.
5) Students compose a short narrative about a day in the life of a seasonal plant, from seed to fully grown.
6) Students write a persuasive essay convincing others to grow a specific seasonal plant in their garden or yard.
7) Students create a seasonal plant report, including information about the plant's habitat, growth patterns, and life span.
8) Students write a set of instructions for how to grow a pineapple plant from a grocery store pineapple crown.
9) Students conduct an interview with a local farmer or greenhouse owner and write a news article about their experiences.
10) Students write a simple poem or riddle about the purpose and function of a greenhouse.
11) Students describe the key features of a greenhouse structure in a short paragraph or labeled diagram.
12) Students imagine and write a story about a day in the life of a plant growing inside a greenhouse.
13) Students write a persuasive letter to a community organization, arguing for the benefits of building a greenhouse in the local area.
14) Students create a set of instructions for how to grow cucumbers or other out-of-season crops in a greenhouse, including key steps and considerations.
15) Students write a simple poem or rhyme about the changing seasons and how they affect plant growth.

### Activities for the Logical Multiple Intelligence for Cycle 1.5

Exemplary proposed activities are:
1) Students measure the growth of a seasonal plant over time (e.g., height, number of leaves) and record the data in a table or chart.
2) Students sort and count the various parts of a seasonal plant (e.g., roots, stems, leaves, flowers) and compare the quantities.
3) Students solve word problems related to the life cycle of a seasonal plant, such as “If a pineapple plant takes 2 years to grow, how old will it be in 3 years?”
4) Students identify and categorize seasonal plants based on their growth patterns (e.g., annual, biennial, perennial).
5) Students calculate the average growth rate of a seasonal plant by measuring its height over several weeks or months.
6) Students create a timeline or cycle diagram to illustrate the different stages of a seasonal plant's life cycle.
7) Students analyze data on the optimal growing conditions (temperature, rainfall, sunlight) for various seasonal plants and identify patterns.
8) Students solve multi-step word problems involving the planting, growth, and harvesting of seasonal plants.
9) Students estimate and measure the dimensions (height, width, circumference) of a pineapple plant or fruit, and compare the measurements to other seasonal plants.
10) Students measure and compare the dimensions of different greenhouse structures, such as the length, width, and height.
11) Students identify and count the number of components (e.g., windows, vents, heating/cooling systems) in a simple greenhouse model or diagram.
12) Students solve word problems related to the growth of crops in a greenhouse, such as “If a cucumber plant grows 2 inches per week in a greenhouse, how tall will it be in 4 weeks?”
13) Students calculate the area or volume of a greenhouse based on its dimensions, and determine how it could accommodate different types of plants.
14) Students analyze data on the yield or production rates of crops grown in greenhouses compared to traditional outdoor methods, and identify any trends or patterns.
16) Students create a bar graph or pictograph to show the number of different seasonal plants found in the school garden or local area.

### Activities for the Kinesthetic Multiple Intelligence for Cycle 1.5

Exemplary proposed activities are:
1) Students play a “plant parts” Simon Says game, where students mimic the movements of different plant parts (roots, stems, leaves, flowers).
2) Students create a seasonal plant relay race, where students take turns carrying plant-themed objects (e.g., watering cans, flower pots) to a designated area.
3) Students engage in a seasonal plant scavenger hunt, where students physically search for and collect real or picture cards of various plants.
4) Students participate in a “grow like a plant” yoga activity, incorporating poses that mimic the growth of a plant from seed to mature plant.
5) Students choreograph a seasonal plant-themed dance or movement sequence, incorporating the changes in growth and the influence of different seasons.
6) Students play a “plant life cycle” tag game, where one student is the “seed” and must “grow” into a mature plant by tagging other students.
7) The teacher creates a seasonal plant obstacle course, where students navigate through different challenges representing the various stages of plant growth.
8) Students engage in a pineapple-themed physical activity, such as a “pineapple pass” game or a “pineapple pose” stretch.
9) Students participate in a greenhouse-themed movement game, where students act out the processes of growing and maintaining plants in a greenhouse environment.
10) Students role-play the construction of a greenhouse, using their bodies to represent the different components (walls, roof, vents, etc.).
11) Students engage in a “greenhouse scavenger hunt,” where students physically search for and identify various greenhouse-related objects or images.
12) Students participate in a greenhouse-themed relay race, where students transport greenhouse supplies (e.g., watering cans, seedlings) to a designated area.
13) Students create a greenhouse-themed dance or movement sequence, incorporating the functions and features of a greenhouse structure.
14) Students engage in a “greenhouse yoga” session, where students assume poses that mimic the growth of plants in a greenhouse environment.
17) Students act out the life cycle of a seasonal plant through movement and dance, starting as a seed and growing into a full plant.

### Activities for the Interpersonal Multiple Intelligence for Cycle 1.5

Exemplary proposed activities are:
1) Students engage in a “Greenhouse Tour” activity, where students take turns leading their classmates on a guided tour of a model or diagram of a greenhouse.
2) Students work in pairs to create a poster or collage about the key features and functions of a greenhouse, then present their work to the class.
3) Students participate in a “Cucumber Cooking Class,” where students collaborate to prepare a healthy dish featuring cucumbers grown in a greenhouse.
4) Students organize a “Greenhouse Debate,” where students take on different roles (e.g., greenhouse owner, environmentalist, or consumer) and argue the pros and cons of greenhouse technology.
18) Students collaborate in small groups to design and build a model of a greenhouse, then present their creation and explain its features to the class.

### Activities for the Intrapersonal Multiple Intelligence for Cycle 1.5

Exemplary proposed activities are:
1) Students create a personal journal or sketchbook to document the growth and changes of a seasonal plant over time.
2) Students reflect on their personal experiences with seasonal plants, such as their favorite parts of a plant or the challenges of caring for them.
3) Students set personal goals for growing or observing a seasonal plant, and track their progress in a self-reflection log.
4) Students write a short story or poem from the perspective of a pineapple plant, expressing its thoughts and feelings throughout its life cycle.
5) Students engage in a mindfulness activity, such as a “plant meditation,” where students visualize the growth and development of a seasonal plant.
6) Students maintain a personal plant growth chart or graph, tracking the measurements and changes in their seasonal plant over time.
7) Students compose a personal narrative about a memorable experience with a seasonal plant, such as planting a seed or harvesting a crop.
8) Students create a personal plan for growing a cucumber plant, including the steps, resources, and potential challenges they may face.
9) Students reflect on the importance of seasonal plants in their own lives, and write a letter to a family member or friend explaining their thoughts.
10) Students engage in a self-guided “pineapple yoga” practice, incorporating poses and movements that mimic the growth and development of a pineapple plant.
11) Students imagine and draw their own personal greenhouse design, including the features and functions they consider most important.
12) Students write a personal journal entry about a day in the life of a greenhouse worker, describing the tasks and experiences they might encounter.
13) Students reflect on the role of greenhouses in their local community and how they might personally benefit from having access to one.
14) Students create a personal list of pros and cons of using greenhouses, and consider how their own experiences and values might influence their perspective.
15) Students engage in a self-guided “greenhouse meditation,” where they visualize the environment and processes within a greenhouse, and how it might affect their personal well-being.

### Activities for the Musical Multiple Intelligence for Cycle 1.5

Exemplary proposed activities are:
1) Students compose a short melody or rhythm that represents the growth and life cycle of a seasonal plant, such as a pineapple.
2) Students create and perform a seasonal plant-themed song or chant, incorporating sounds and movements that mimic the various parts of the plant.
3) Students participate in a “Seed to Flower” musical game, where students move and dance like different stages of plant growth while listening to corresponding music.
4) Students explore the use of instruments to create a “Rainstorm Symphony,” simulating the sounds of a seasonal plant receiving water.
5) Students compose a short jingle or tune to promote the benefits of seasonal plants, and perform it for the class.
6) Students write and perform a short musical play or skit about the life cycle of a seasonal plant, such as a cucumber.
7) Students create a “Greenhouse Soundscape,” using a variety of instruments and sounds to represent the different processes and features of a greenhouse.
8) Students engage in a “Plant Part Percussion” activity, where students use their bodies or simple instruments to create rhythms inspired by the various parts of a plant.
9) Students compose a musical piece that depicts the different seasons and how they affect the growth and development of seasonal plants.
10) Students participate in a “Pineapple Parade,” marching and playing instruments to a lively, pineapple-themed melody.
11) Students create a short song or chant that explains the purpose and features of a greenhouse, and perform it for the class.
12) Students explore the use of musical instruments to represent the sounds and functions of a greenhouse, such as the hum of fans or the patter of rain on the roof.
13) Students compose a “Greenhouse Lullaby,” using soothing melodies and rhythms to simulate the calming environment of a greenhouse.
14) Students write and perform a “Greenhouse Rap,” incorporating facts and information about the importance of greenhouses in a rhythmic and engaging way.
15) Students engage in a “Greenhouse Music Improvisation,” where students take turns creating short musical phrases that represent different aspects of greenhouse operations.

### Activities for the Naturalistic Multiple Intelligence for Cycle 1.5

Exemplary proposed activities are:
1) Students take a field trip to a local farm, garden, or nursery to observe and document the growth and life cycle of seasonal plants, such as pineapples and cucumbers.
2) Students create a nature journal to record observations, drawings, and reflections on the seasonal changes and adaptations of different plants.
3) Students participate in a “Seed Planting Expedition,” where students plant their own seeds and track the growth and development of their plants over time.
4) Students engage in a “Sustainable Seasonal Plant Challenge,” where students research and implement sustainable growing practices for their plants.
5) Students organize a “Pineapple Propagation Party,” where students learn about and practice techniques for propagating pineapple plants from cuttings.
6) Students conduct a “Greenhouse Observation Study,” where students monitor the environmental conditions and growth patterns of plants in a greenhouse over an extended period.
7) Students create a class “Seasonal Plant Classroom Garden,” using sustainable gardening methods and tracking the plants'progress throughout the seasons.
8) Students participate in a “Cucumber Conservation Campaign,” where students research and advocate for the importance of sustainable cucumber farming practices.
9) Students engage in a “Pineapple Permaculture Project,” where students design and implement a sustainable, self-sustaining system for growing pineapples.
10) Students organize a “Sustainable Seasonal Plant Swap,” where students exchange seeds, seedlings, or cuttings of locally-adapted, sustainable seasonal plants.
11) Students explore the use of renewable energy sources, such as solar power or wind turbines, to power a model greenhouse and observe the effects on plant growth.
12) Students participate in a “Greenhouse Microclimate Investigation,” where students study the temperature, humidity, and other environmental factors within a greenhouse and how they relate to sustainable plant cultivation.
13) Students create a “Sustainable Greenhouse Design Challenge,” where students work in teams to design and build a model greenhouse using recycled or eco-friendly materials.
14) Students engage in a “Greenhouse Composting Collaboration,” where students collect and compost organic matter to create nutrient-rich soil for use in the greenhouse.
10) Students participate in a “Greenhouse Water Conservation Campaign,” where students research and implement water-saving techniques, such as rainwater harvesting or drip irrigation, to promote sustainable greenhouse practices.

### Example 10. Plants (cycle 1.6 Main Parts of Green Plant) Module

Another example of an application of the invention's camera/computer program system is as applied to the Plants (Cycle 1.6 Main Parts of Green Plant) module is shown below. Recommended activities are provided for each multiple intelligence (spatial, kinesthetic, logical, linguistic, musical, naturalistic, interpersonal or intrapersonal).

### Activities for the Spatial Multiple Intelligence for Cycle 1.6

Exemplary proposed activities are:
1) Students color a detailed diagram of a green plant, labeling the roots, stem, leaves, and flowers using colored pencils or markers.
2) Students design a plant-themed board game where players stick pieces based on the stages of a plant's life cycle.
3) Students create a plant “wanted poster” describing the unique features of the plant.
4) Students observe under the microscope the plant cross-sections, highlighting the internal structures of roots, stems, leaves, and flowers.
5) Students design a plant-themed mural, using various textures, shapes, and colors to depict the different parts of a green plant.
6) Students construct a 3D plant model using a 3D printing pen or other technology, focusing on accurately representing the main structures of a plant.

### Activities for the Linguistic Multiple Intelligence for Cycle 1.6

Exemplary proposed activities are:
1) Students create a plant parts vocabulary book, with each page defining and illustrating a key component.
2) Students compose a plant-themed story, incorporating the main parts of a green plant into the narrative.
3) Students participate in a “Plant Part Show and Tell,” where students describe the function of a specific plant component.
4) Students write and perform a short play or skit highlighting the importance of the plant parts.
5) Students research and write informative reports on the unique features and roles of plant roots, stems, leaves, and flowers.
6) Students engage in a “Plant Part Riddle” challenge, where students write and solve clues about the different components.
7) Students compose a persuasive essay arguing for the importance of protecting and preserving green plants.
8) Students create a plant-themed podcast or audio recording, explaining the main parts and their functions.
7) Students write and illustrate a How-To guide for growing and caring for a healthy green plant.

### Activities for the Logical Multiple Intelligence for Cycle 1.6

Exemplary proposed activities are:
1) Students create a classification system for the different parts of a green plant, using Venn diagrams or other organizational tools.
2) Students conduct a “Plant Part Measurement” experiment, where students measure and compare the size, weight, or other quantitative aspects of plant components.
3) Students engage in a “Plant Part Sorting” activity, where students group and categorize different plant parts based on their functions or characteristics.
4) Students solve plant-themed word problems or logic puzzles that incorporate the main parts of a green plant.
5) Students analyze plant growth data, such as the rate of stem elongation or leaf production, and draw conclusions about the plant's development.
6) Students design a flow chart or decision tree to demonstrate the interdependence and relationships between the different plant parts.
7) Students conduct a “Plant Part Experiment,” where students test hypotheses about the roles and functions of specific plant components.
8) Students create a “Plant Part Math Challenge,” where students solve multi-step problems involving the measurement, calculation, or comparison of plant structures.
9) Students engage in a “Plant Part Coding” activity, where students use programming logic to simulate the growth and interactions of the different plant parts.
8) Students analyze and interpret scientific data about plant physiology, such as the absorption of water and nutrients by roots or the process of photosynthesis in leaves.

### Activities for the Kinesthetic Multiple Intelligence for Cycle 1.6

Exemplary proposed activities are:
1) Students act out the growth and development of a green plant through movement and dance.
2) Students participate in a “Plant Part Scavenger Hunt,” where students physically locate and touch different plant components.
3) Students create a “Plant Part Obstacle Course,” with students moving their bodies to mimic the functions of roots, stems, leaves, and flowers.
4) Students engage in a “Seed Germination” simulation, where students curl up on the floor and slowly “sprout” into a full plant.
5) Students play a “Plant Part Charades” game, where students pantomime the actions of specific plant components.
6) Students construct a life-size model of a green plant using their bodies and recycled materials.
7) Students participate in a “Plant Part Yoga” session, with poses and stretches inspired by the different plant structures.
8) Students role-play the life cycle of a green plant, with students acting out the stages of growth and development.
9) Students engage in a “Plant Part Tag” game, where students move around the classroom representing different plant components.
9) Students create a “Plant Part Dance,” incorporating choreographed movements that symbolize the functions of roots, stems, leaves, and flowers.

### Activities for the Interpersonal Multiple Intelligence for Cycle 1.6

Exemplary proposed activities are:
1) Students work in pairs or small groups to create a collaborative poster or mural depicting the main parts of a green plant.
2) Students participate in a “Plant Part Jigsaw” activity, where students share their knowledge with each other to complete a larger understanding.
3) Students engage in a “Plant Part Interview,” where students interview one another about the functions of different plant components.
4) Students organize a “Plant Part Experts” panel, where students take on the roles of different plant parts and answer questions from their peers.
5) Students collaborate in a “Plant Part Storybook” project, where each student contributes a page or section about a specific plant component.
6) Students work in teams to design and build a miniature greenhouse, discussing the roles and relationships of the plant parts.
7) Students participate in a “Plant Part Debate,” where students argue for the importance of different plant components.
8) Students engage in a “Plant Part Teach-Back” activity, where students teach their classmates about a specific plant part and its function.
9) Students collaborate in a “Plant Part Museum,” where students create interactive exhibits and presentations to share their knowledge.
10) Students work together to plan and execute a “Plant Part Awareness Campaign,” raising awareness about the importance of green plants.

### Activities for the Intrapersonal Multiple Intelligence for Cycle 1.6

Exemplary proposed activities are:
1) Students create a personal journal or sketchbook to document their observations and reflections on the different parts of a green plant.
2) Students write a short story or poem from the perspective of a specific plant part, expressing its thoughts and feelings.
3) Students set personal goals for learning about and caring for a green plant, and track their progress in a self-reflection log.
4) Students engage in a mindfulness activity, such as a “Plant Meditation,” where students visualize the growth and development of a green plant.
5) Students compose a personal narrative about a memorable experience with a green plant, such as planting a seed or observing its growth.
6) Students maintain a personal plant growth chart or graph, tracking the changes and development of a green plant over time.
7) Students create a personal plan for growing a green plant, including the steps, resources, and potential challenges they may face.
8) Students reflect on the importance of green plants in their own lives, and write a letter to a family member or friend explaining their thoughts.
9) Students engage in a self-guided “Plant Yoga” practice, incorporating poses and movements that mimic the growth and development of a green plant.
11) Students imagine and design their own personal greenhouse or garden, considering the needs and roles of the different plant parts.

### Activities for the Musical Multiple Intelligence for Cycle 1.6

Exemplary proposed activities are:
1) Students compose a short melody or rhythm that represents the growth and development of a green plant.
2) Students create and perform a plant-themed song or chant, incorporating sounds and movements that mimic the various parts of the plant.
3) Students participate in a “Seed to Flower” musical game, where students move and dance like different stages of plant growth while listening to corresponding music.
4) Students explore the use of instruments to create a “Photosynthesis Symphony,” simulating the sounds of a plant's internal processes.
5) Students compose a short jingle or tune to promote the importance of green plants, and perform it for the class.
6) Students write and perform a short musical play or skit about the life cycle of a green plant, highlighting the roles of the main parts.
7) Students create a “Plant Part Percussion” ensemble, where students use their bodies or simple instruments to create rhythms inspired by the various components.
12) Students compose a musical piece that depicts the different seasons and how they affect the growth and development of green plants.

### Activities for the Naturalistic Multiple Intelligence for Cycle 1.6

Exemplary proposed activities are:
1) Students engage in a Plant Observation Scavenger Hunt activity wherein the teacher takes students on a nature walk around the school grounds or a local park. The teacher gives them a checklist of the main plant parts (roots, stems, leaves, flowers, fruits) and has them search for and identify examples of each.
2) Students engage in a Dissecting a Plan activity wherein the teacher provides students with a simple plant, such as a flowering weed or a leaf-bearing stem, and have them carefully dissect it to observe the different structures up close. They can label a diagram to show the main parts.
3) Students engage in a Seed Investigation activity wherein the teacher gives each student a few different types of seeds (e.g. bean, corn, sunflower). The teacher has the students observe the seeds closely, draw them, and then plant them. Over time, the students can observe and document how the seeds germinate and develop into seedlings, noting the emergence of roots, stems, and leaves.
4) Students engage in a Plant Part Matching Game activity wherein the teacher creates cards with images or names of the principal plant parts. The teacher has students work in pairs or small groups to match the parts and explain the function of each.
5) Students engage in a “What Do Plants Need? Experiment” activity wherein the teacher sets up a simple experiment where students grow plants under different conditions (e.g. with/without water, light, soil). The students observe and discuss how the plants respond to the changes in their environment.
6) Students engage in a Plant Life Cycle Mural activity wherein the class creates a large mural or poster that illustrates the complete life cycle of a plant, from seed to mature plant producing new seeds.
7) Students engage in a Plant Part Relay activity wherein the teacher divides the class into teams. The teacher calls out a plant part, and has students race to be the first to run and touch an example of that part in the classroom or schoolyard.

### Example 11. Plants (cycle 1.7 Components of Habitat) Module

Another example of an application of the invention's camera/computer program system is as applied to the Plants (Cycle 1.7 Components of Habitat (desert plant-water plant-forest plant)) module is shown below. Recommended activities are provided for each multiple intelligence (spatial, kinesthetic, logical, linguistic, musical, naturalistic, interpersonal or intrapersonal).

### Activities for the Spatial Multiple Intelligence for Cycle 1.7

Exemplary proposed activities are:
1) Students watch a video about habitats, discuss the different features of each one.
2) Students arrange plants from a habitat into a collage.
3) Students construct a pop-up book that illustrates a habitat and plant adaptation.
4) Students analyze satellite imagery to identify different habitat types.
5) Students create an origami representation of a specific plant.

### Activities for the Linguistic Multiple Intelligence for Cycle 1.7

Exemplary proposed activities are:
1) Students write a descriptive poem about the sights, sounds, and smells of a habitat.
2) Students conduct an interview with an expert on a particular plant community.
3) Students craft a children's storybook about the life cycle of a forest, sea, or desert plant.
4) Students compose a script for a play that explores the relationships within a habitat.
5) Students debate the importance of conserving different types of habitats and plant diversity.
6) Students write a research paper on the unique adaptations of plants in a specific biome.
7) Students create a glossary of specialized vocabulary related to plant biology and ecology.
8) Students record a podcast episode that educates listeners about a habitat and its plants.
9) Students develop a persuasive presentation to encourage environmental stewardship.
10) Students compose a series of haikus that capture the essence of a plant community.

### Activities for the Logical Multiple Intelligence for Cycle 1.7

Exemplary proposed activities are:
1) Students analyze data on plant distribution and population trends in different habitats.
2) Students design a mathematical model to predict the impact of environmental changes on a habitat.
3) Students solve logic puzzles that require understanding the interdependence of habitat components.
4) Students create a flowchart to illustrate the energy flow or nutrient cycling within a plant-based ecosystem.
5) Students develop an algorithm to categorize plants based on their structural and functional adaptations.
6) Students conduct experiments to test hypotheses about plant responses to environmental factors.
7) Students calculate the surface area and volume of different plant parts to understand their functions.
8) Students analyze patterns in the growth and development of plants in various habitats.
9) Students devise a system for classifying plants based on their taxonomic relationships.
11) Students solve word problems that apply mathematical concepts to real-world plant ecology scenarios.

### Activities for the Kinesthetic Multiple Intelligence for Cycle 1.7

Exemplary proposed activities are:
1) Students participate in a scavenger hunt to locate and physically interact with different plant specimens.
2) Students engage in a “plant yoga” session, mimicking the movements and poses of various plant structures.
3) Students perform a dance or movement piece that dramatizes the life cycle of a plant.
4) Students construct a model of a plant or habitat using a variety of materials and hands-on techniques.
5) Students participate in a guided nature walk, using the senses to explore and appreciate plants in their natural environment.
6) Students engage in a hands-on activity to dissect a plant and identify its internal structures.
7) Students role play the different roles and interactions of organisms within a habitat.
8) Students utilize tools and equipment to conduct field observations and measurements of plants.
9) Students participate in a team-building activity that requires collaborative problem-solving related to plant adaptations.
12) Students create a physical representation or demonstration of a plant-related scientific concept or process.

### Activities for the Interpersonal Multiple Intelligence for Cycle 1.7

Exemplary proposed activities are:
1) Students conduct interviews with community members or experts to learn about local plant communities.
2) Students collaborate in small groups to design and present a public awareness campaign about habitat conservation.
3) Students organize a community service project to remove invasive plants or plant native species.
4) Students participate in a panel discussion or debate about the societal impacts of plant-related issues.
5) Students work together to create a multimedia presentation that highlights the importance of plant diversity.
6) Students engage in a role-playing activity that explores the perspectives of different stakeholders in a habitat-related conflict.
7) Students organize a garden or nature-themed event to educate and engage the local community.
8) Students participate in a collaborative research project to study the interactions between plants and other organisms.
9) Students lead a guided tour or nature walk, sharing knowledge and insights about the plants in a local habitat.
10) Students coordinate a fundraising or advocacy campaign to support the conservation of a threatened plant species or ecosystem.

### Activities for the Intrapersonal Multiple Intelligence for Cycle 1.7

Exemplary proposed activities are:
1) Students keep a reflective journal documenting personal observations, insights, and emotional responses to plants and habitats.
2) Students engage in a guided meditation or visualization exercise focused on connecting with the natural world.
3) Students create a personal action plan for reducing one's environmental impact and promoting plant conservation.
4) Students compose a series of introspective essays exploring the significance of plants in one's own life and culture.
5) Students develop a self-assessment tool to evaluate one's own understanding and appreciation of plant diversity.
6) Students engage in a mindfulness activity, such as a silent nature walk or plant-focused sketching session.
7) Students reflect on and write about personal experiences, memories, or feelings associated with specific plants or habitats.
8) Students create a personal symbol or totem representing one's connection to the natural world and its plants.
9) Students develop a self-guided learning plan to deepen one's knowledge and appreciation of a particular plant community or ecosystem.
11) Students engage in a reflective exercise to identify personal values, beliefs, or priorities related to plant conservation and environmental stewardship.

### Activities for the Musical Multiple Intelligence for Cycle 1.7

Exemplary proposed activities are:
1) Students conduct field observations and record detailed notes and sketches about the plants in a local habitat.
2) Students participate in a citizen science project to monitor and report on the health and diversity of plant populations.
3) Students design and implement a schoolyard or community garden, incorporating native plant species.
4) Students engage in a plant-identification scavenger hunt, using field guides and other resources to recognize different species.
5) Students analyze and interpret data on the distribution, abundance, and adaptations of plants in various biomes.
6) Students participate in a habitat restoration or conservation project, such as removing invasive species or planting native plants.
7) Students create a multi-sensory exhibit or diorama that showcases the unique features and adaptations of plants from a specific habitat.
8) Students engage in a plant-focused outdoor adventure, such as a nature hike, camping trip, or canoe excursion.
9) Students develop a plant-themed board game or interactive learning activity to teach about plant ecology and diversity.
12) Students conduct experiments to explore the physiological processes and environmental responses of different plant species.

### Activities for the Naturalistic Multiple Intelligence for Cycle 1.7

Exemplary proposed activities are:
1) Students compose original songs, poems, or soundscapes that capture the rhythms, melodies, and harmonies of a particular habitat or plant community.
2) Students analyze the ways in which different cultures have incorporated plants into their traditional music, dance, and storytelling.
3) Students create a musical instrument using natural materials found in a habitat, such as plant stems, leaves, or seeds.
4) Students perform a musical piece that dramatizes the life cycle or adaptations of a specific plant species.
5) Students engage in a group activity where participants create a “symphony of nature,” using their voices and bodies to mimic the sounds of a habitat.
6) Students explore the use of plant-based materials, such as bamboo or tree bark, in the construction of musical instruments.
7) Students compose a series of plant-themed lullabies or meditative compositions to promote relaxation and connection with nature.
8) Students analyze the ways in which certain plants have been used in traditional healing practices, and incorporate these elements into original musical compositions.
9) Students collaborate with others to create a multi-sensory, plant-themed performance that integrates music, dance, and visual art.
10) Students develop a plant-themed playlist or soundscape that can be used to enhance learning or contemplation in an educational or therapeutic setting.

The present invention has been described in detail, including the preferred embodiments thereof. However, it will be appreciated that those skilled in the art, upon consideration of the present disclosure, may make modifications and/or improvements on this invention that fall within the scope and spirit of the invention.

What is claimed is:

1. A multiple intelligences recognition system comprising a digital camera and computer program, wherein the digital camera captures photos and videos and stores said photos and videos in a multiple intelligences recognition system, wherein the multiple intelligences recognition system analyzes the captured photos and videos into types of multiple intelligences and recommends at least one activity for each deficient multiple intelligence identified.

2. The multiple intelligences recognition system of claim 1, wherein the multiple intelligence is selected from the group consisting of spatial, kinesthetic, logical, linguistic, musical, naturalistic, interpersonal and intrapersonal.

3. The multiple intelligences recognition system of claim 2, wherein the spatial multiple intelligence is spatial perception, spatial visualization, spatial reasoning, pattern recognition, design, artistic expression, navigation or a combination thereof.

4. The multiple intelligences recognition system of claim 2, wherein the kinesthetic multiple intelligence is body control, fine motor skills, physical expression, athletic ability, body language, kinesthetic learning or a combination thereof.

5. The multiple intelligences recognition system of claim 2, wherein the logical multiple intelligence is logical reasoning, deductive reasoning, problem-solving, mathematical operations, data analysis or a combination thereof.

6. The multiple intelligences recognition system of claim 2, wherein the linguistic multiple intelligence is verbal communication, written communication, reading comprehension, vocabulary, wordplay, storytelling or a combination thereof.

7. The multiple intelligences recognition system of claim 2, wherein the musical multiple intelligence is musical perception, musical memory, instrumental proficiency, vocal proficiency, musical composition, music theory, musical performance or a combination thereof.

8. The multiple intelligences recognition system of claim 2, wherein the naturalistic multiple intelligence is observational skills, ecological knowledge, environmental stewardship, outdoor skills, agricultural knowledge, geographical knowledge, environmental design, conservation biology or a combination thereof.

9. The multiple intelligences recognition system of claim 2, wherein the interpersonal multiple intelligence is communication, collaboration, leadership, networking, social awareness, conflict resolution, cultural competence or a combination thereof.

10. The multiple intelligences recognition system of claim 2, wherein the intrapersonal multiple intelligence is self-awareness, self-reflection, goal setting, metacognition, mindfulness, autonomy, resilience or a combination thereof.

11. The multiple intelligences recognition system of claim 1, wherein the computer program normalizes and cleans said photos and videos to ensure data quality.

12. The multiple intelligences recognition system of claim 1, wherein the computer program comprises a step of creating a feedback loop to continuously improve the machine learning models based on new data and prediction outcomes.

13. A multiple intelligences recognition system, comprising: a data ingestion module configured to receive and preprocess data; a feature extraction module operable to extract relevant features from the preprocessed data; a machine learning model training module configured to train machine learning models on the extracted features; a prediction module operable to generate predictive outcomes based on real-time input data using the trained machine learning models; and a user interface enabling users to input data and view predictions.

14. The multiple intelligences recognition system of claim 13, wherein the data ingestion module obtains data from a digital camera or a mobile digital device.

15. The multiple intelligences recognition system of claim 13, wherein the features of the feature extraction module are multiple intelligences.

16. The multiple intelligences recognition system of claim 15, wherein the multiple intelligence is selected from the group consisting of spatial, kinesthetic, logical, linguistic, musical, naturalistic, interpersonal and intrapersonal.

17. The multiple intelligences recognition system of claim 13, wherein the machine learning model training module is adapted to implement ensemble learning techniques for improved prediction accuracy.

18. The multiple intelligences recognition system of claim 17, further comprising a recommendation module that provides actionable insights based on the generated predictions.

19. The multiple intelligences recognition system of claim 13, wherein the data ingestion module supports real-time data streaming for continuous data flow and predictive analytics.
